(19) United States
(12) Patent Application Publication
(10) Pub. No.: US 2025/0227718 A1
(43) Pub. Date: Jul. 10, 2025

(54) PHYSICAL DOWNLINK CONTROL CHANNEL (PDCCH) MONITORING CAPABILITY FOR MULTI-CELL SCHEDULING

(71) Applicant: Intel Corporation, Santa Clara, CA (US)

(72) Inventors: Yingyang Li, Beijing (CN); Yi Wang, Beijing (CN); Gang Xiong, Portland, OR (US)

(73) Assignee: Intel Corporation, Santa Clara, CA (US)

(21) Appl. No.: 18/849,897

(22) PCT Filed: Apr. 21, 2023
(86) PCT No.: PCT/US2023/019344

§ 371 Date: Sep. 23, 2024

Related U.S. Application Data
(60) Provisional application No. 63/421,369, filed on Nov. 1, 2022.
(60) Provisional application No. 63/352,916, filed on Jun. 16, 2022.
(60) Provisional application No. 63/336,056, filed on Apr. 28, 2022.
(60) Provisional application No. 63/334,006, filed on Apr. 22, 2022.

(51) Int. Cl. H04W 72/232; H04W 72/1263

(52) U.S. Cl. CPC H04W 72/232; H04W 72/1263

(57) ABSTRACT

An apparatus of a New Radio (NR) Node B (gNB), a method, and a storage medium. The apparatus is to identify a downlink control information (DCI) size budget related to a DCI format for multi-cell scheduling; generate a physical downlink control channel (PDCCH) transmission to schedule, in a plurality of cells, shared channel (SCH) transmissions, the PDCCH transmission including an indication of the DCI size budget; and send the PDCCH transmission for transmission to a User Equipment (UE) within a scheduling cell of the plurality of cells.

### CROSS REFERENCE TO RELATED APPLICATIONS

This application claims the benefit of and priority from U.S. Provisional Patent Application No. 63/334,006 entitled “PHYSICAL DOWNLINK CONTROL CHANNEL (PDCCH) MONITORING CAPABILITY FOR MULTI-CELL SCHEDULING,” filed Apr. 22, 2022, from U.S. Provisional Patent Application No. 63/336,056 entitled “PHYSICAL DOWNLINK CONTROL CHANNEL (PDCCH) MONITORING CAPABILITY FOR MULTI-CELL SCHEDULING,” filed Apr. 28, 2022, from U.S. Provisional Patent Application No. 63/352,916 entitled “PHYSICAL DOWNLINK CONTROL CHANNEL (PDCCH) MONITORING CAPABILITY FOR MULTI-CELL SCHEDULING,” filed Jun. 16, 2022, and from U.S. Provisional Patent Application No. 63/421,369 entitled “PHYSICAL DOWNLINK CONTROL CHANNEL (PDCCH) MONITORING CAPABILITY FOR MULTI-CELL SCHEDULING,” filed Nov. 1, 2022.

### FIELD

Various embodiments generally may relate to the field of wireless communications in a cellular network.

### BACKGROUND

Various embodiments generally may relate to the field of wireless communications, and especially to the scheduling of shared channel transmissions through a physical downlink control channel (PDCCH).

### BRIEF DESCRIPTION OF THE DRAWINGS

FIG. 1 shows a communication network according to some embodiments.

FIG. 2 shows a cellular wireless network between a UE and an access node (AN) according to some embodiments.

FIG. 3 shows components, according to some example embodiments, able to read instructions from a machine-readable or computer-readable medium.

FIG. 4 is a flow chart of an example procedure of adaptive inter-frequency RSTD measurement gap pattern configuration according to one embodiment.

FIG. 5 illustrates a signaling diagram for multi-cell scheduling according to a first example.

FIG. 6 illustrates a signaling diagram for multi-cell scheduling according to a second example.

example.

FIG. 7 illustrates a signaling diagram for multi-cell scheduling according to a third example.

FIG. 8 is a flow chart of a first process according to an embodiment.

FIG. 9 is a flow chart of a second process according to another embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

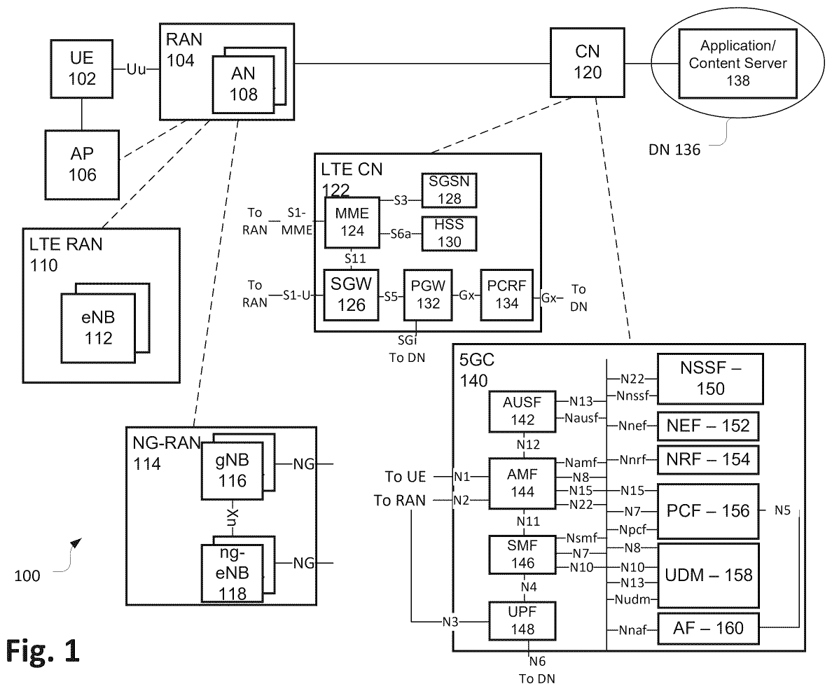

In some embodiments, the electronic device(s), network(s), system(s), chip(s) or component(s), or portions or implementations thereof, of FIGS. 1-3, or some other figure herein, may be configured to perform one or more processes, techniques, or methods as described herein, or portions thereof. One such process is depicted in FIGS. 1-3. In some embodiments, the process may be performed by a New Radio (NR) Node B (gNB) or by a NR User Equipment (UE).

An apparatus of a New Radio (NR) Node B (gNB), a method, and a storage medium. One or more processors of the apparatus are to identify scheduling information for a plurality of cells and related to one or more SCH (SCH) transmissions, the one or more SCH transmissions including one or more physical uplink SCH (PUSCH) transmissions or one or more physical downlink SCH (PDSCH) transmissions; generate a physical downlink control channel (PDCCH) based on the scheduling information; and send the PDCCH for transmission to a user equipment (UE) on a single scheduling cell of the plurality of cells.

### Systems and Implementations

FIGS. 1-4 illustrate various systems, devices, and components that may implement aspects of disclosed embodiments.

FIG. 1 illustrates a network 100 in accordance with various embodiments. The network 100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 100 may include a UE 102, which may include any mobile or non-mobile computing device designed to communicate with a RAN 104 via an over-the-air connection. The UE 102 may be communicatively coupled with the RAN 104 by a Uu interface. The UE 102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102 may additionally communicate with an AP 106 via an over-the-air connection. The AP 106 may manage a WLAN connection, which may serve to offload some/all network traffic from the RAN 104. The connection between the UE 102 and the AP 106 may be consistent with any IEEE 802.11 protocol, wherein the AP 106 could be a: wireless fidelity (Wi-Fi®) router. In some embodiments, the UE 102, RAN 104, and AP 106 may utilize cellular-WLAN aggregation (for example, LWA/LWIP). Cellular-WLAN aggregation may involve the UE 102 being configured by the RAN 104 to utilize both cellular radio resources and WLAN resources.

The RAN 104 may include one or more access nodes, for example, AN 108. AN 108 may terminate air-interface protocols for the UE 102 by providing access stratum protocols including RRC, PDCP, RLC, MAC, and LI protocols. In this manner, the AN 108 may enable data/voice connectivity between CN 120 and the UE 102. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102 with an air interface for network access. The UE 102 may be simultaneously connected with a plurality of cells provided by the same or different ANs of the RAN 104. For example, the UE 102 and RAN 104 may use carrier aggregation to allow the UE 102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-cNB, etc.

The RAN 104 may provide the air interface over a licensed spectrum or an unlicensed spectrum. To operate in the unlicensed spectrum, the nodes may use LAA, cLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102 or AN 108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, cNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 104 may be an NG-RAN 114 with gNBs, for example, gNB 116, or ng-eNBs, for example, ng-cNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102 can be configured with multiple BWPs where each BWP configuration has a different SCS. When a BWP change is indicated to the UE 102, the SCS of the transmission is changed as well. Another use case example of BWP is related to power saving. In particular, multiple BWPs can be configured for the UE 102 with different amount of frequency resources (for example, PRBs) to support data transmission under different traffic loading scenarios. A BWP containing a smaller number of PRBs can be used for data transmission with small traffic load while allowing power saving at the UE 102 and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102 to facilitate paging, bearer activation/deactivation, handovers, gateway selection, authentication, etc.

The SGW 126 may terminate an SI interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102 and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 1 36 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102 and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102 and the RAN 104 and to subscribe to notifications about mobility events with respect to the UE 102. The AMF 144 may be responsible for registration management (for example, for registering UE 102), connection management, reachability management, mobility management, lawful interception of AMF-related events, and access authentication and authorization. The AMF 144 may provide transport for SM messages between the UE 102 and the SMF 146, and act as a transparent proxy for routing SM messages. AMF 144 may also provide transport for SMS messages between UE 102 and an SMSF. AMF 144 may interact with the AUSF 142 and the UE 102 to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102 over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102 and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102. The NSSF 150 may also determine allowed NSSAI and the mapping to the subscribed S-NSSAIs, if needed. The NSSF 150 may also determine the AMF set to be used to serve the UE 102, or a list of candidate AMFs based on a suitable configuration and possibly by querying the NRF 154. The selection of a set of network slice instances for the UE 102 may be triggered by the AMF 144 with which the UE 102 is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npof service-based interface.

The UDM 158 may handle subscription-related information to support the network entities' handling of communication sessions, and may store subscription data of UE 102. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102) for the NEF 152. The Nudr service-based interface may be exhibited by the UDR 221 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3^{rd} party services to be geographically close to a point that the UE 102 is attached to the network. This may reduce latency and load on the network. To provide edge-computing implementations, the 5GC 140 may select a UPF 148 close to the UE 102 and execute traffic steering from the UPF 148 to data network 136 via the N6 interface. This may be based on the UE subscription data, UE location, and information provided by the AF 160. In this way, the AF 160 may influence UPF (re) selection and traffic routing. Based on operator deployment, when AF 160 is considered to be a trusted entity, the network operator may permit AF 160 to interact directly with relevant NFs. Additionally, the AF 160 may exhibit an Naf service-based interface.

The data network 136 may represent various network operator services, Internet access, or third party services that may be provided by one or more servers including, for example, application/content server 138.

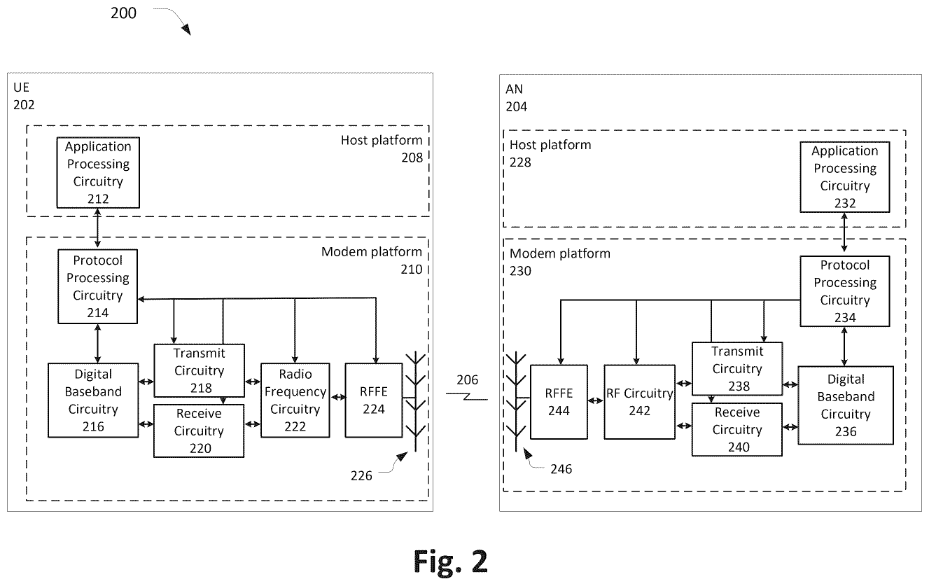

FIG. 2 schematically illustrates a wireless network 200 in accordance with various embodiments. The wireless network 200 may include a UE 202 in wireless communication with an AN 204. The UE 202 and AN 204 may be similar to, and substantially interchangeable with, like-named components described elsewhere herein.

The UE 202 may be communicatively coupled with the AN 204 via connection 206. The connection 206 is illustrated as an air interface to enable communicative coupling, and can be consistent with cellular communications protocols such as an LTE protocol or a 5G NR protocol operating at mmWave or sub-6 GHZ frequencies.

The UE 202 may include a host platform 208 coupled with a modem platform 210. The host platform 208 may include application processing circuitry 212, which may be coupled with protocol processing circuitry 214 of the modem platform 210. The application processing circuitry 212 may run various applications for the UE 202 that source/sink application data. The application processing circuitry 212 may further implement one or more layer operations to transmit/receive application data to/from a data network. These layer operations may include transport (for example UDP) and Internet (for example, IP) operations.

The protocol processing circuitry 214 may implement one or more of layer operations to facilitate transmission or reception of data over the connection 206. The layer operations implemented by the protocol processing circuitry 214 may include, for example, MAC, RLC, PDCP, RRC and NAS operations.

The modem platform 210 may further include digital baseband circuitry 216 that may implement one or more layer operations that are “below” layer operations performed by the protocol processing circuitry 214 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 210 may further include transmit circuitry 218, receive circuitry 220, RF circuitry 222, and RF front end (RFFE) 224, which may include or connect to one or more antenna panels 226. Briefly, the transmit circuitry 218 may include a digital-to-analog converter, mixer, intermediate frequency (IF) components, etc.; the receive circuitry 220 may include an analog-to-digital converter, mixer, IF components, etc.; the RF circuitry 222 may include a low-noise amplifier, a power amplifier, power tracking components, etc.; RFFE 224 may include filters (for example, surface/bulk acoustic wave filters), switches, antenna tuners, beamforming components (for example, phase-array antenna components), etc. The selection and arrangement of the components of the transmit circuitry 218, receive circuitry 220, RF circuitry 222, RFFE 224, and antenna panels 226 (referred generically as “transmit/receive components”) may be specific to details of a specific implementation such as, for example, whether communication is TDM or FDM, in mm Wave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 214 may include one or more instances of control circuitry (not shown) to provide control functions for the transmit/receive components.

A UE reception may be established by and via the antenna panels 226, RFFE 224, RF circuitry 222, receive circuitry 220, digital baseband circuitry 216, and protocol processing circuitry 214. In some embodiments, the antenna panels 226 may receive a transmission from the AN 204 by receive-beamforming signals received by a plurality of antennas/antenna elements of the one or more antenna panels 226.

A UE transmission may be established by and via the protocol processing circuitry 214, digital baseband circuitry 216, transmit circuitry 218, RF circuitry 222, RFFE 224, and antenna panels 226. In some embodiments, the transmit components of the UE 204 may apply a spatial filter to the data to be transmitted to form a transmit beam emitted by the antenna elements of the antenna panels 226.

Similar to the UE 202, the AN 204 may include a host platform 228 coupled with a modem platform 230. The host platform 228 may include application processing circuitry 232 coupled with protocol processing circuitry 234 of the modem platform 230. The modem platform may further include digital baseband circuitry 236, transmit circuitry 238, receive circuitry 240, RF circuitry 242, RFFE circuitry 244, and antenna panels 246. The components of the AN 204 may be similar to and substantially interchangeable with like-named components of the UE 202. In addition to performing data transmission/reception as described above, the components of the AN 208 may perform various logical functions that include, for example, RNC functions such as radio bearer management, uplink and downlink dynamic radio resource management, and data packet scheduling.

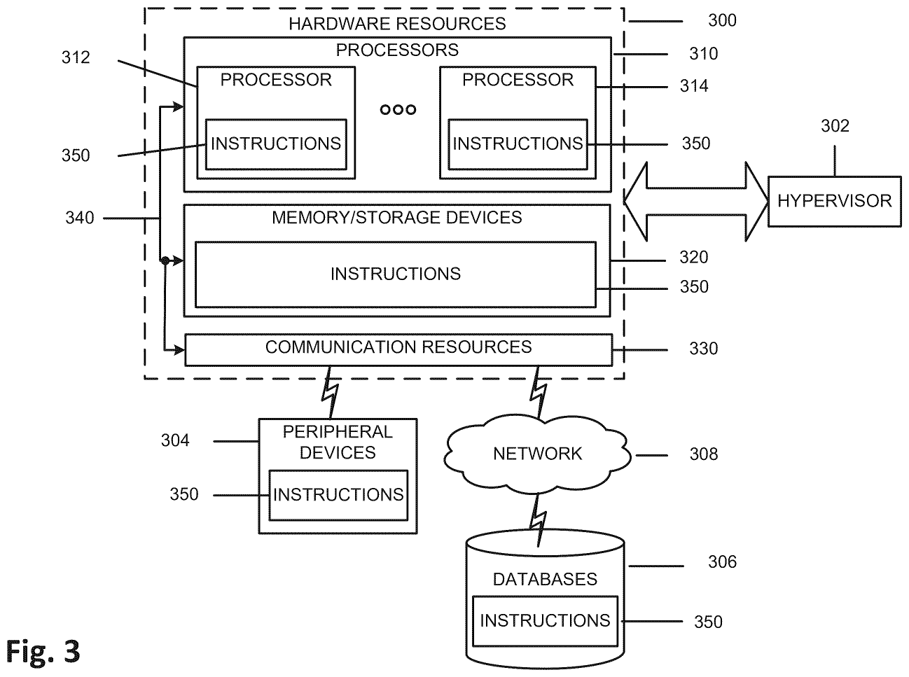

FIG. 3 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 3 shows a diagrammatic representation of hardware resources 300 including one or more processors (or processor cores) 310, one or more memory/storage devices 320, and one or more communication resources 330, each of which may be communicatively coupled via a bus 340 or other interface circuitry. For embodiments where node virtualization (e.g., NFV) is utilized, a hypervisor 302 may be executed to provide an execution environment for one or more network slices/sub-slices to utilize the hardware resources 300.

The processors 310 may include, for example, a processor 312 and a processor 314. The processors 310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 320 may include main memory, disk storage, or any suitable combination thereof. The memory/storage devices 320 may include, but are not limited to, any type of volatile, non-volatile, or semi-volatile memory such as dynamic random access memory (DRAM), static random access memory (SRAM), erasable programmable read-only memory (EPROM), electrically crasable programmable read-only memory (EEPROM), Flash memory, solid-state storage, etc.

The communication resources 330 may include interconnection or network interface controllers, components, or other suitable devices to communicate with one or more peripheral devices 304 or one or more databases 306 or other network elements via a network 308. For example, the communication resources 330 may include wired communication components (e.g., for coupling via USB, Ethernet, etc.), cellular communication components, NFC components, Bluetooth® (or Bluetooth® Low Energy) components, Wi-Fi® components, and other communication components.

Instructions 350 may comprise software, a program, an application, an applet, an app, or other executable code for causing at least any of the processors 310 to perform any one or more of the methodologies discussed herein. The instructions 350 may reside, completely or partially, within at least one of the processors 310 (e.g., within the processor's cache memory), the memory/storage devices 320, or any suitable combination thereof. Furthermore, any portion of the instructions 350 may be transferred to the hardware resources 300 from any combination of the peripheral devices 304 or the databases 306. Accordingly, the memory of processors 310, the memory/storage devices 320, the peripheral devices 304, and the databases 306 are examples of computer-readable and machine-readable media.

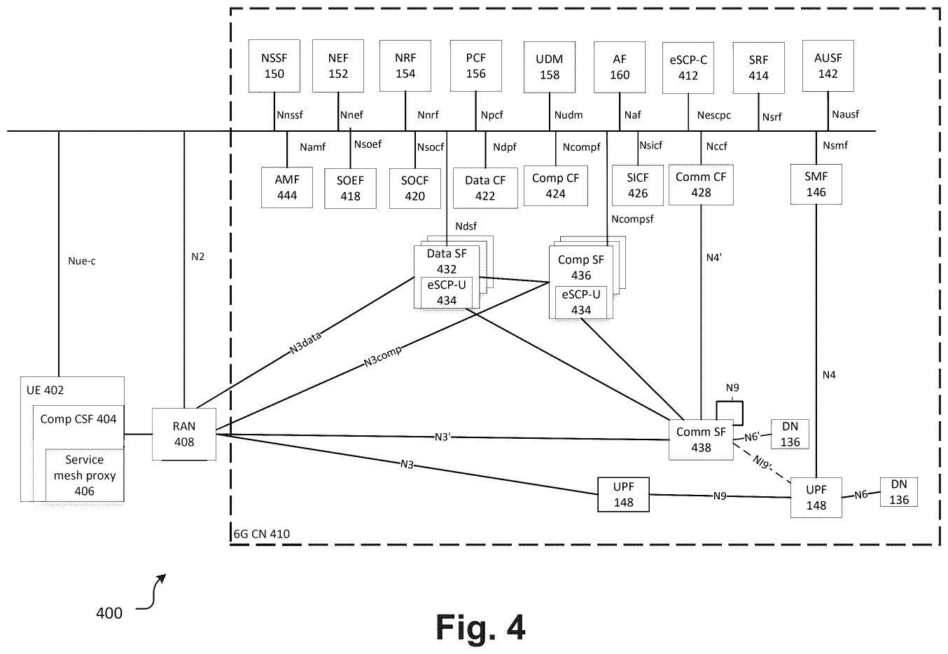

FIG. 4 illustrates a network 400 in accordance with various embodiments. The network 400 may operate in a matter consistent with 3GPP technical specifications or technical reports for 6G systems. In some embodiments, the network 400 may operate concurrently with network 100. For example, in some embodiments, the network 400 may share one or more frequency or bandwidth resources with network 100. As one specific example, a UE (e.g., UE 402) may be configured to operate in both network 400 and network 100. Such configuration may be based on a UE including circuitry configured for communication with frequency and bandwidth resources of both networks 100 and 400. In general, several elements of network 400 may share one or more characteristics with elements of network 100. For the sake of brevity and clarity, such elements may not be repeated in the description of network 400.

The network 400 may include a UE 402, which may include any mobile or non-mobile computing device designed to communicate with a RAN 408 via an over-the-air connection. The UE 402 may be similar to, for example, UE 102. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 4, in some embodiments the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 4, the UE 402 may be communicatively coupled with an AP such as AP 106 as described with respect to FIG. 1. Additionally, although not specifically shown in FIG. 4, in some embodiments the RAN 408 may include one or more ANss such as AN 108 as described with respect to FIG. 1. The RAN 408 and/or the AN of the RAN 408 may be referred to as a base station (BS), a RAN node, or using some other term or name.

The UE 402 and the RAN 408 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mm Wave” frequency ranges.

The RAN 408 may allow for communication between the UE 402 and a 6G core network (CN) 410. Specifically, the RAN 408 may facilitate the transmission and reception of data between the UE 402 and the 6G CN 410. The 6G CN 410 may include various functions such as NSSF 150, NEF 152, NRF 154, PCF 156, UDM 158, AF 160, SMF 146, and AUSF 142. The 6G CN 410 may additional include UPF 148 and DN 136 as shown in FIG. 4.

Additionally, the RAN 408 may include various additional functions that are in addition to, or alternative to, functions of a legacy cellular network such as a 4G or 5G network. Two such functions may include a Compute Control Function (Comp CF) 424 and a Compute Service Function (Comp SF) 436. The Comp CF 424 and the Comp SF 436 may be parts or functions of the Computing Service Plane. Comp CF 424 may be a control plane function that provides functionalities such as management of the Comp SF 436, computing task context generation and management (e.g., create, read, modify, delete), interaction with the underlaying computing infrastructure for computing resource management, etc., Comp SF 436 may be a user plane function that serves as the gateway to interface computing service users (such as UE 402) and computing nodes behind a Comp SF instance. Some functionalities of the Comp SF 436 may include: parse computing service data received from users to compute tasks executable by computing nodes; hold service mesh ingress gateway or service API gateway; service and charging policies enforcement; performance monitoring and telemetry collection, etc. In some embodiments, a Comp SF 436 instance may serve as the user plane gateway for a cluster of computing nodes. A Comp CF 424 instance may control one or more Comp SF 436 instances.

Two other such functions may include a Communication Control Function (Comm CF) 428 and a Communication Service Function (Comm SF) 438, which may be parts of the Communication Service Plane. The Comm CF 428 may be the control plane function for managing the Comm SF 438, communication sessions creation/configuration/releasing, and managing communication session context. The Comm SF 438 may be a user plane function for data transport. Comm CF 428 and Comm SF 438 may be considered as upgrades of SMF 146 and UPF 148, which were described with respect to a 5G system in FIG. 1. The upgrades provided by the Comm CF 428 and the Comm SF 438 may enable service-aware transport. For legacy (e.g., 4G or 5G) data transport, SMF 146 and UPF 148 may still be used.

Two other such functions may include a Data Control Function (Data CF) 422 and Data Service Function (Data SF) 432 may be parts of the Data Service Plane. Data CF 422 may be a control plane function and provides functionalities such as Data SF 432 management, Data service creation/configuration/releasing, Data service context management, etc. Data SF 432 may be a user plane function and serve as the gateway between data service users (such as UE 402 and the various functions of the 6G CN 410) and data service endpoints behind the gateway. Specific functionalities may include: parse data service user data and forward to corresponding data service endpoints, generate charging data, report data service status.

Another such function may be the Service Orchestration and Chaining Function (SOCF) 420, which may discover, orchestrate and chain up communication/computing/data services provided by functions in the network. Upon receiving service requests from users, SOCF 420 may interact with one or more of Comp CF 424, Comm CF 428, and Data CF 422 to identify Comp SF 436, Comm SF 438, and Data SF 432 instances, configure service resources, and generate the service chain, which could contain multiple Comp SF 436, Comm SF 438, and Data SF 432 instances and their associated computing endpoints. Workload processing and data movement may then be conducted within the generated service chain. The SOCF 420 may also responsible for maintaining, updating, and releasing a created service chain.

Another such function may be the service registration function (SRF) 414, which may act as a registry for system services provided in the user plane such as services provided by service endpoints behind Comp SF 436 and Data SF 432 gateways and services provided by the UE 402. The SRF 414 may be considered a counterpart of NRF 154, which may act as the registry for network functions.

Other such functions may include an evolved service communication proxy (eSCP) and service infrastructure control function (SICF) 426, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 412 and eSCP-U 434, for control plane service communication proxy and user plane service communication proxy, respectively. The SICF 426 may control and configure eCSP instances in terms of service traffic routing policies, access rules, load balancing configurations, performance monitoring, etc.

Another such function is the AMF 444. The AMF 444 may be similar to 144, but with additional functionality. Specifically, the AMF 444 may include potential functional repartition, such as move the message forwarding functionality from the AMF 444 to the RAN 408.

Another such function is the service orchestration exposure function (SOEF) 418. The SOEF may be configured to expose service orchestration and chaining services to external users such as applications.

The UE 402 may include an additional function that is referred to as a computing client service function (comp CSF) 404. The comp CSF 404 may have both the control plane functionalities and user plane functionalities, and may interact with corresponding network side functions such as SOCF 420, Comp CF 424, Comp SF 436, Data CF 422, and/or Data SF 432 for service discovery, request/response, compute task workload exchange, etc. The Comp CSF 404 may also work with network side functions to decide on whether a computing task should be run on the UE 402, the RAN 408, and/or an element of the 6G CN 410.

The UE 402 and/or the Comp CSF 404 may include a service mesh proxy 406. The service mesh proxy 406 may act as a proxy for service-to-service communication in the user plane. Capabilities of the service mesh proxy 406 may include one or more of addressing, security, load balancing, etc.

### INTRODUCTION

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich contents and services.

NR supports a wide range of spectrum in different frequency ranges. It is expected that there will be increasing availability of spectrum in the market for 5G Advanced possibly due to re-farming from the bands originally used for previous cellular generation networks. Especially for frequency range (FR1) bands, the available spectrum blocks tend to be more fragmented and scattered with narrower bandwidths. For FR2 bands and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

One motivation is to increase flexibility and spectral/power efficiency on scheduling data over multiple cells including intra-band cells and inter-band cells. The current scheduling mechanism only allows scheduling of single cell physical uplink shared channel (PUSCH) or physical downlink shared channel (PDSCH) per a scheduling downlink control information (DCI). With more available scattered spectrum bands or wider bandwidth spectrum, the need of simultaneous scheduling of multiple cells is expected to be increasing. To reduce the control overhead, it is beneficial to extend from single-cell scheduling to multi-cell PUSCH/PDSCH scheduling with a single scheduling DCI. More specifically, a DCI is used to schedule PDSCH or PUSCH transmissions in more than one cell or component carrier (CC), where each PDSCH or PUSCH is scheduled in one cell or CC.

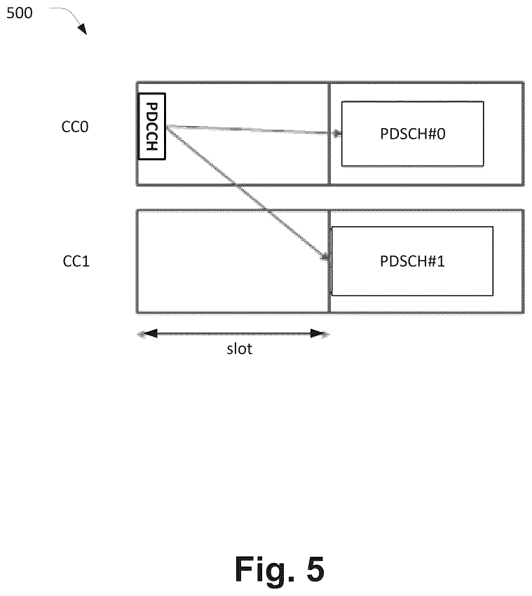

FIG. 5 illustrates a signaling diagram 500 in the time domain one example of multi-cell scheduling for PDSCHs according to some embodiments. In the example, one physical downlink control channel (PDCCH) is used to schedule two PDSCHs in two different cells, i.e., PDSCH #0 in CC0 and PDSCH #1 in CC1.

For multi-cell scheduling, the number of sizes of downlink control information (DCI) formats and the maximum numbers of monitored PDCCH candidates and non-overlapped CCEs need to be defined considering the capability for PDCCH monitoring at the UE side. Therefore, embodiments herein relate to mechanisms to handle PDCCH monitoring capability for multi-cell scheduling. In particular, embodiments may relate to one or more of the following:
DCI size budget for multi-cell scheduling; or.
Maximum numbers of monitored PDCCH candidates and non-overlapped CCEs.

The configured serving cells for carrier aggregation (CA) or dual connectivity (DC) operations can be divided into multiple sets. The PDSCH and PUSCH transmissions on a cell in a set of cells are only scheduled by a PDCCH on the same cell or other cell(s) in the same set of cells. For a set of cells containing PCell or PSCell, the PCell or PSCell is the scheduling cell, except for the case that a DL or UL transmission on PCell could be scheduled by a scheduling SCell. In the latter case, the DCI for multi-cell scheduling could be configured on the scheduling SCell.

Within a set of configured serving cells, only one cell can be configured as the scheduling cell for the cells in a set of cells, and all cells in the set of cells can be scheduled by the scheduling cell. Alternatively, two or more cells can be configured as the scheduling cells for the cells in a set of cells, and all cells in the set of cells can be scheduled by the two or more scheduling cells. Specifically, a DCI for single-cell scheduling may be transmitted in respective cell using self-scheduling while the DCIs for multi-cell scheduling may be transmitted in one or more scheduling cells.

A cell may be scheduled by the DCI formats for multi-cell scheduling from one or more scheduling cells. One or multiple DCI formats for multi-cell PDSCH or PUSCH scheduling from a scheduling cell can be configured on the scheduling cell. Note: The multiple DCI formats for multi-cell scheduling may be generated by the different configurations of a DCI format defined in the relevant 3GPP specifications for PDSCH or PUSCH scheduling. For example, a single DCI format 0_1 or 1_1 for multi-cell scheduling may be defined in the specification, then, multiple sets of parameters of the DCI fields of the DCI format 0_1 or 1_1 may be configured to generate the multiple DCI formats for multi-cell scheduling. The multiple DCI formats for multi-cell scheduling may be associated with same or different search space sets. The multiple DCI format for multi-cell scheduling may have same or different DCI sizes. Further, for a cell that can be scheduled by a DCI format for multi-cell scheduling, a DCI format for single-cell scheduling in addition to the DCI format for multi-cell scheduling may be configured on the scheduling cell, which results in increased number of DCI sizes for PDCCH detection at UE. For a cell that is not schedulable by any DCI format for multi-cell scheduling, a DCI format for single-cell scheduling may be configured on the scheduling cell.

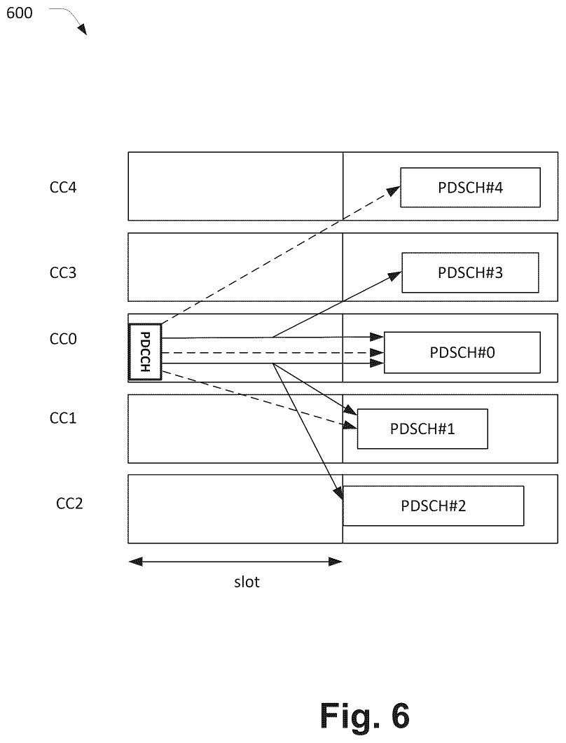

FIG. 6 illustrates a signaling diagram 600 showing one example of multiple DCI formats for multi-cell scheduling from the scheduling cell CC0. In FIG. 6, the 5 cells, CC0/1/2/3/4 can be scheduled by a same or different DCI format on CC0. A first DCI format for multi-cell scheduling can schedule CC0 and CC3, while a second alternative DCI format for multi-cell scheduling can be used to schedule CC0, CC1 and CC2. In FIG. 6, both the two DCI formats for multi-cell scheduling can schedule CC0. If CC4 is not schedulable by multi-cell scheduling, a single-cell DCI format on the scheduling cell CC0 is configured to cross-carrier schedule CC4. In FIG. 6, a single-cell DCI format on the scheduling cell CC0 can be additionally used for self-scheduling of CC0. Further, a single-cell DCI format on the scheduling cell CC0 can be additionally configured to cross-carrier schedule CC1.

Throughout this disclosure, for a DCI format for multi-cell scheduling, the maximum set of cells that can be scheduled by the DCI format include any cell that is schedulable by the DCI format. gNB may schedule one, multiple or all cells in the maximum set by a PDCCH of the DCI format. Correspondingly, the maximum number of cells that can be scheduled by the DCI format equals to the number of cells in the maximum set. In one example in FIG. 6, if the same DCI format is used to schedule CC0, CC1 and CC2, or schedule CC0 and CC3, e.g., by a field indicating different scheduled cells in the DCI format, the maximum set of cells that can be scheduled by the DCI format is CC0, CC1, CC2 and CC3. In another example in FIG. 6, if the first DCI format that schedules CC0, CC1 and CC2 is a different DCI format from the second DCI format that schedules CC0 and CC3, the maximum set of cells that can be scheduled by the two DCI formats are determined separately. For the first DCI format, it includes CC0, CC1 and CC2, while for the second DCI format, it includes CC0, and CC3.

### DCI Size Budget for Multi-Cell Scheduling

In the legacy NR system, there is limitation on the maximum number of DCI sizes that could be detected by a UE for a cell. In NR Rel-15, a UE expects to monitor PDCCH candidates for up to 4 sizes of DCI formats that include up to 3 sizes of DCI formats with CRC scrambled by C-RNTI, CS-RNTI, or MCS-C-RNTI per serving cell. The UE counts a number of sizes for DCI formats per serving cell based on the set of DCI formats configured for monitoring in respective search space sets for the corresponding active DL BWP. One potential issue is how to count the number of DCI size for a DCI format for multi-cell scheduling.

Denote the maximum number of sizes of all DCI formats for a serving cell as M, and the maximum number of sizes of DCI formats with CRC scrambled by C-RNTI for the serving cell as N. In the legacy NR system, M=4, N=3. When a DCI format for multi-cell scheduling is configured on the scheduling cell, the DCI size budget for any scheduling or scheduled cell may be the same as the legacy NR (Rel-15/16/17), i.e., M=4, N=3. Alternatively, the DCI size budget for the scheduling or scheduled cell may be defined, configured or determined by the configuration of the DCI format(s) for multi-cell scheduling.

In one embodiment, the DCI size budget of the scheduling cell or a scheduled cell, i.e., M and/or N can be configured by high layer signaling. For example, the scheduling cell may be configured with larger DCI size budget, i.e., M>4 and N>3. Correspondingly, a scheduled cell may be configured with a DCI size budget of M≤4 and N≤3. By this way, the overall UE capability on the number of detected DCI sizes is not increased.

In another embodiment, the DCI size budget of the scheduling cell can be increased when multi-cell scheduling from the scheduling cell is configured. For example, one or multiple DCI formats for multi-cell scheduling from the scheduling cell may be only considered as DCI formats of the scheduling cell. Consequently, at least part of the DCI size budget of a scheduled cell may be assigned to the scheduling cell. To count the number of DCI size, a DCI format for multi-cell scheduling that is transmitted on a scheduling cell can be counted to the scheduling cell only. For example, the counter of the scheduling cell is increased by 1 if the DCI size of the DCI format for multi-cell scheduling is not counted yet.

The DCI size budget may be still defined per cell. Since the DCI size budget of the scheduling cell is increased, to maintain the same UE capability on the number of detected DCI size, the DCI size budget for a scheduled cell other than the scheduling cell can be reduced accordingly or unchanged. For example, if the DCI size budget of the scheduling cell is increased by 1 due to a scheduled cell that is scheduled by a DCI format for multi-cell scheduling, the DCI size budget of the scheduled cell needs to be decreased by 1. Alternatively, if all the DCI formats are considered as DCI formats of the scheduling cell, only the DCI size budget of the scheduling cell needs to be defined, configured or determined by the configuration of the DCI format(s) for multi-cell scheduling.

In one option, if a maximum of X cells can be scheduled by the scheduling cell using multi-cell scheduling, the DCI size budget for the scheduling cell can be scaled by X time, i.e., (X·M, X·N). Alternatively, only number of sizes of DCI formats with CRC scrambled by C-RNTI can be scaled by X times. Therefore, the DCI size budget is (X·N+M−N, X·N), e.g., (3X+1, 3X). There may be only one DCI format for multi-cell scheduling configured on the scheduling cell. In this case, X equals to the number of cells that can be scheduled by the DCI format. Alternatively, multiple DCI formats for multi-cell scheduling can be configured on the scheduling cell. In the latter case, X is the total number of cells that can be scheduled by at least one DCI format for multi-cell scheduling. With this option, the DCI size budget of a cell other than the scheduling cell may be reduced to M=N=0, if the cell cannot be configured with any single-cell scheduling DCI format.

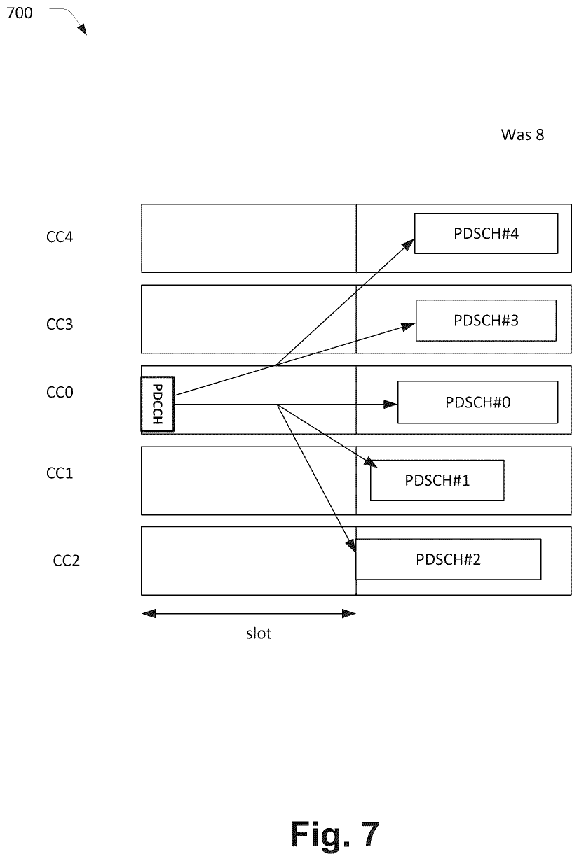

FIG. 7 illustrates one example of multiple DCI formats for multi-cell scheduling from the scheduling cell CC0. In FIG. 7, the 5 cells, CC0/1/2/3/4 can be scheduled by a same or different DCI format on CC0. A first DCI format for multi-cell scheduling can schedule CC3 & CC4, while a second DCI format for multi-cell scheduling can be schedule CC0, CC1 & CC2. Since the 5 cells can be scheduled by DCI formats for multi-cell scheduling, the DCI size budget of the scheduling cell CC0 can be increased to (16, 15).

In another option, if a maximum of X cells can be scheduled by the scheduling cell using multi-cell scheduling, the DCI size budget for the scheduling cell can be increased by X−1 if the scheduling cell can be scheduled by multi-cell scheduling, i.e., (M+X−1, N+X−1), or by X if the scheduling cell cannot be scheduled by multi-cell scheduling, i.e., (M+X, N+X). With this option, the DCI size budget of a cell other than the scheduling cell may be decreased by 1 to avoid increased UE capability on detected DCI sizes, if the cell can be scheduled by the DCI format for multi-cell scheduling.

In another option, if a maximum of Y cells can be scheduled by a DCI format for multi-cell scheduling from the scheduling cell, the DCI size budget for the scheduling cell can be increased by Y−1 if the scheduling cell can be scheduled by the DCI format, i.e., (M+Y−1, N+Y−1), or by Y if the scheduling cell cannot be scheduled by the DCI format, i.e., (M+Y, N+Y). Note: the value Y may be different for the different DCI formats for multi-cell scheduling. If multiple DCI formats for multi-cell scheduling are configured on the scheduling cell, this procedure to increase the DCI size budget of the scheduling cell is performed for each DCI format.

In another option, for a cell that can be scheduled by one or multiple DCI formats for multi-cell scheduling and is not the scheduling cell, the number of different DCI sizes of the multiple DCI formats are added to the DCI size budget of the scheduling cell. With this option, the DCI size budget of the cell needs to be decreased by the number of different DCI sizes of the one or multiple DCI formats for multi-cell scheduling, to avoid increased UE capability on detected DCI sizes. This procedure to increase the DCI size budget of the scheduling cell is performed for each cell except for the scheduling cell. In FIG. 6, CC1 can be scheduled by a DCI format for multi-cell scheduling, therefore the DCI size budget of the scheduling cell CC0 may be increased by 1. CC2 can also be scheduled by a DCI format for multi-cell scheduling, therefore the DCI size budget of the scheduling cell CC0 may be increased by 1 again. Further, CC3 can be scheduled by a DCI format for multi-cell scheduling, therefore the DCI size budget of the scheduling cell CC0 may be increased by 1 too. Therefore, the DCI size budget of the scheduling cell CC0 may be increased by 3 in total for FIG. 6.

In another option, for a DCI format for multi-cell scheduling on the scheduling cell, if the DCI format is counted toward the DCI size budget of the scheduling cell, the DCI size budget of the scheduling cell is increased by one, i.e., (M+1, N+1). This procedure to increase the DCI size budget of the scheduling cell is performed for each DCI format for multi-cell scheduling on the scheduling cell. In this option, if two or more DCI formats for multi-cell scheduling on the scheduling cell has the same DCI size, the increase of the DCI size budget for the scheduling cell is only performed once for the two or more DCI formats. In FIG. 6, for a first DCI format that schedules CC0 & CC3, the DCI size budget of the scheduling cell may be increased by 1. Further, for a second DCI format that schedules CC0, CC1 & CC2, the DCI size budget of the scheduling cell may be increased by 1 too. Therefore, the DCI size budget of the scheduling cell CC0 may be increased by 2 in total for FIG. 6.

In another option, for each DCI format that is for single-cell or multi-cell scheduling and is to schedule at least one cell other than the scheduling cell, the DCI size budget of the scheduling cell is increased by one, i.e., (M+1, N+1). This procedure to increase the DCI size budget of the scheduling cell is performed for each DCI format for multi-cell scheduling on the scheduling cell. In this option, if two or more DCI formats on the scheduling cell has the same DCI size, the increase of the DCI size budget for the scheduling cell is only performed once for the two or more DCI formats. In FIG. 6, 4 DCI formats are configured to be able to schedule at least one cell other than the scheduling cell, therefore, the DCI size budget of the scheduling cell CC0 may be increased by 4 in total for FIG. 6.

In another option, for each DCI format for multi-cell scheduling that can schedule the scheduling cell and other scheduled cell(s), the DCI size budget for the scheduling cell is increased by A, DCI size budget of any of the scheduled cells other than the scheduling cell is decreased by B or unchanged. The value A and B can be fixed to ½. Alternatively, the value A equals to (Y−1)/Y while the value B equals to 1/Y, where Y is the maximum number of cells that can be scheduled by a DCI format for multi-cell scheduling. For each DCI format for multi-cell scheduling that can only schedule the scheduled cells other than the scheduling cell, the DCI size budget for the scheduling cell is increased by 1, and the DCI size budget of any of the scheduled cells is decreased by ½ or 1/Y or unchanged. Y is the maximum number of cells that can be scheduled by a DCI format for multi-cell scheduling, which can be configured by higher layers or determined in accordance with the configured cell indication table for multi-cell scheduling. Note: a floor ( ) round ( ) or ceil ( ) operation may be applied to the determined DCI size budget for a cell.

For example, in FIG. 7, corresponding to the DCI format scheduling CC0/1/2, the DCI size budget of the scheduling cell CC0 is increased by ½, while the DCI size budget of CC1/2 is respectively decreased by ½. Further, corresponding to the DCI format scheduling CC3/4, the DCI size budget of the scheduling cell CC0 is increased by 1, while the DCI size budget of CC3/4 is respectively decreased by ½. In summary, the DCI size budget of CC0 becomes (5.5, 4.5), while the DCI size budget of CC1/2/3/4 is (3.5, 2.5).

In another example, in FIG. 7, if there exists a DCI format scheduling PDSCH transmission on CC0/1/2 and a DCI format scheduling PUSCH transmission on CC0/1/2, the DCI size budget of the scheduling cell CC0 can be increased by 1, while the DCI size budget of CC1/2 is respectively decreased by 1. Further, if there exists a DCI format scheduling PDSCH transmission on CC3/4 and a DCI format scheduling PUSCH transmission on CC3/4, the DCI size budget of the scheduling cell CC0 is increased by 2, while the DCI size budget of CC3/4 is respectively decreased by 1. In summary, the DCI size budget of CC0 becomes (7, 6), while the DCI size budget of CC1/2/3/4 is (3, 2).

In another option, if multiple DCI formats configured on the scheduling cell have the same DCI size, this DCI size is counted as one DCI size in the determination of the number of DCI sizes of the scheduling cell. If the multiple DCI formats include a DCI format for single-cell scheduling, the DCI size budget of the scheduling cell is not changed for this DCI size. Otherwise, if the multiple DCI formats include a DCI format for multi-cell scheduling that only schedules the scheduled cells other than the scheduling cell, the DCI size budget of the scheduling cell is increased by 1 for this DCI size. Further, if each DCI format of the multiple DCI formats can schedule the scheduling cell and other scheduled cell(s), the DCI size budget for the scheduling cell is increased by A. To determine the DCI size budget of a scheduled cell other than the scheduling cell, for a DCI format for multi-cell scheduling with a different DCI size that can schedule the scheduled cell, and the DCI size budget of the scheduled cell is decreased by B or unchanged. The value A and B can be fixed to ½. Alternatively, the value A equals to (Y−1)/Y while the value B equals to 1/Y, where Y is the maximum number of cells that can be scheduled by a DCI format for multi-cell scheduling.

In another embodiment, the DCI size budget of the scheduling cell can be increased when multi-cell scheduling from the scheduling cell is configured. The DCI size budget may be still defined per cell. For each DCI format for multi-cell scheduling that can only schedule the scheduled cells other than the scheduling cell, the DCI size budget for the scheduling cell is increased by ½, and the DCI size budget of any of the scheduled cells is decreased by ½ or unchanged. Note: a floor ( ) round ( ) or ceil ( ) operation may be applied to the determined DCI size budget for a cell. In this option, to count the number of DCI sizes of the scheduling cell, the counter is increased by ½ if the DCI size of the DCI format for multi-cell scheduling is not counted yet. If a DCI format for single-cell scheduling and a DCI format for multi-cell scheduling have the same DCI size for a cell, the DCI size is counted for the cell assuming the DCI format for single-cell scheduling.

In another embodiment, for a DCI format for multi-cell scheduling, the DCI size budget of a reference cell that can be scheduled by the DCI format can be increased. Correspondingly, the DCI size budget of other cell(s) that can be scheduled by the DCI format can be decreased. Alternatively, the DCI size budget of other cell(s) that can be scheduled by the DCI format may be unchanged. Note: a floor ( ) round ( ) or ceil ( ) operation may be applied to the determined DCI size budget for a cell. The reference cell could be determined from the maximum set of cells that can be scheduled by the DCI format, though gNB may only schedule a subset of the maximum set of cells by a PDCCH with the DCI format. For example, the reference cell can be the cell with the lowest cell index from all the cells that can be scheduled by the DCI format. Alternatively, the reference cell may be configured by high layer signaling from all the cells that can be scheduled by the DCI format. Alternatively, if the scheduling cell can be scheduled by the DCI format, the reference cell is the scheduling cell. Otherwise, the reference cell can be a scheduled cell. Alternatively, the reference cell can be a scheduled cell that can be scheduled by the DCI format and is not the scheduling cell. To count the number of DCI sizes, the DCI format can be counted to the reference cell only. For example, the counter of the reference cell is increased by 1 if the DCI size of the DCI format for multi-cell scheduling is not counted yet.

In one option, for each DCI format for multi-cell scheduling, the DCI size budget of the reference cell of the DCI format is increased by A. In one example, the DCI size budget of any other cells that can be scheduled by the DCI format is decreased by B. The value A and B can be fixed to ½. Alternatively, the value A equals to (Y−1)/Y while the value B equals to 1/Y. Y is the maximum number of cells that can be scheduled by the DCI format. In another example, the DCI size budget of any other cells that can be scheduled by the DCI format is unchanged.

For example, in FIG. 7, corresponding to the DCI format scheduling CC0/1/2, assuming the scheduling cell CC0 is the reference cell, the DCI size budget of CC0 is increased by ½, while the DCI size budget of CC1/2 is respectively decreased by ½. Further, corresponding to the DCI format scheduling CC3/4, assuming the CC3 is the reference cell, the DCI size budget of CC3 is increased by ½, while the DCI size budget of CC4 is decreased by ½. In summary, the DCI size budget of CC0 or CC3 becomes (4.5, 3.5), while the DCI size budget of CC1/2/4 is (3.5, 2.5).

In another example, in FIG. 7, if there exists a DCI format scheduling PDSCH transmission on CC0/1/2 and a DCI format scheduling PUSCH transmission on CC0/1/2, assuming the scheduling cell CC0 is the reference cell, the DCI size budget of the scheduling cell CC0 can be increased by 1, while the DCI size budget of CC1/2 is respectively decreased by 1. Further, if there exists a DCI format scheduling PDSCH transmission on CC3/4 and a DCI format scheduling PUSCH transmission on CC3/4, assuming the CC3 is the reference cell, the DCI size budget of CC3 is increased by 1, while the DCI size budget of CC4 is decreased by 1. In summary, the DCI size budget of CC0 or CC3 becomes (5, 4), while the DCI size budget of CC1/2/4 is (3, 2).

In another option, if multiple DCI formats configured on the same reference cell have the same DCI size, this DCI size is counted as one DCI size in the determination of the number of DCI sizes of the reference cell. If the multiple DCI formats include a DCI format for single-cell scheduling, the DCI size budget of the reference cell is not changed due to this DCI size. Otherwise, the DCI size budget of the reference cell is increased by A. The DCI size budget of any other cells that can be scheduled by the DCI format is decreased by B if the DCI size is different for the cell or unchanged. The value A and B can be fixed to ½. Alternatively, the value A equals to (Y−1)/Y while the value B equals to 1/Y, where Y is the maximum number of cells that can be scheduled by the DCI format.

In another option, if a cell can be scheduled by a DCI for multi-cell PDSCH scheduling and a DCI for multi-cell PUSCH scheduling, and if the cell is the reference cell for the two DCIs, the DCI size budget of the cell is increased by 1. If the cell is only the reference cell for one of the two DCIs, the DCI size budget of the cell is not changed. Further, if the cell is not the reference cell for any of the two DCIs, the DCI size budget of the cell is decreased by 1.

For the above embodiments, Y can be the maximum number of cells that are configured for multi-cell scheduling. Note that gNB may only configure a subset of cells which can be scheduled by the DCI format for multi-cell scheduling.

In one embodiment, to count the number of sizes of DCI format for a scheduling or scheduled cell, the DCI format(s) for multi-cell scheduling may need to be handled specially. The number of DCI sizes counted for the scheduling or scheduled cell should not exceed the corresponding DCI size budget value N.

In one option, a DCI format for multi-cell scheduling from the scheduling cell is considered as one DCI format of each cell that can be scheduled by the DCI format. For a cell that is scheduled by the DCI format, if this DCI format has a DCI size that is different from other DCI format(s) for the cell, the counter of the number of DCI sizes for the cell is increased by 1. In FIG. 7, since each cell can be scheduled by one DCI format for multi-cell scheduling, one DCI size may be counted for each cell.

In another option, a DCI format for multi-cell scheduling from the scheduling cell is considered as one DCI format of each cell that can be scheduled by the DCI format and is not the scheduling cell. For a cell that can be scheduled by the DCI format and is not the scheduling cell, if this DCI format has a DCI size that is different from other DCI format(s) for the cell, the counter of the number of DCI sizes for the cell is increased by 1. In FIG. 7, since each cell of CC1/2/3/4 can be scheduled by one DCI format for multi-cell scheduling, one DCI size may be counted for each cell of CC1/2/3/4. In FIG. 7, though CC0 is also schedulable by a DCI format for multi-cell scheduling, no DCI size is counted to the scheduling cell.

In another option, a DCI format for multi-cell scheduling from the scheduling cell is considered as 1/Y DCI format of each cell that can be scheduled by the DCI format, where Y is the maximum number of the cells that can be scheduled by the DCI format. To count the number of DCI sizes for a cell that can be scheduled by the DCI format, a value 1/Y is added to the number of DCI sizes of the cell corresponding to the DCI format. In FIG. 7, corresponding to the DCI format that schedules CC3 & CC4, ½ DCI size may be counted to CC3 & CC4 respectively. On the other hand, corresponding to the DCI format that schedules CC0, CC1 & CC2, ⅓ DCI size may be counted to CC0, CC1 & CC2 respectively.

In another option, a DCI format for multi-cell scheduling from the scheduling cell is considered as 1/Y DCI format of each cell that can be scheduled by the DCI format and is not the scheduling cell, where Y is the maximum number of the cells that can be scheduled by the DCI format and are not the scheduling cell. To count the number of DCI sizes for a cell that can be scheduled by the DCI format and is not the scheduling cell, a value 1/Y is added to the number of DCI sizes of the cell corresponding to the DCI format. In FIG. 7, corresponding to the DCI format that schedules CC3 & CC4, ½ DCI size may be counted to CC3 & CC4 respectively. On the other hand, corresponding to the DCI format that schedules CC0, CC1 & CC2, ½ DCI size may be counted to CC1 & CC2 respectively. In FIG. 7, though CC0 is also schedulable by a DCI format for multi-cell scheduling, no DCI size is counted to the scheduling cell.

In another option, a DCI format for multi-cell scheduling from the scheduling cell is considered as one DCI format of the scheduling cell only. In other words, the DCI format is not counted as a DCI format for any other cell that can be scheduled by the DCI format. If this DCI format has a DCI size that is different from other DCI format(s) for the scheduling cell, the counter of the number of DCI sizes for the scheduling cell is increased by 1. Note: if multiple DCI formats for multi-cell scheduling with different DCI sizes are configured on the scheduling cell, the number of DCI formats with different sizes for the scheduling is increased accordingly. In FIG. 7, there are two DCI formats for multi-cell scheduling, so 2 DCI size may be counted to the scheduling cell.

In another option, a DCI format for multi-cell scheduling from the scheduling cell is considered as one DCI format of a reference cell only. In other words, the DCI format is not treated as a DCI format for any other cell that can be scheduled by the DCI format. For example: the reference cell could be the cell with lowest cell index that can be scheduled by the DCI format.
Alternatively, the reference cell may be the cell with lowest index that can be configured or scheduled by the DCI format other than the scheduling cell.
Alternatively, the reference cell may be the scheduling cell if the scheduling cell can be configured or scheduled by the DCI format, otherwise, a scheduled cell, e.g., the cell with lowest index that can be scheduled by the DCI format.
Alternatively, the reference cell can be configured by high layer signaling, e.g., in the configuration of CrossCarrierSchedulingConfig or SearchSpace.
Alternatively, if a SS set of the DCI format for multi-cell scheduling is configured on a cell X of the cells that can be scheduled by the DCI format, the reference cell can be the cell X. Note that cell X may be a cell that can be configured or scheduled by DCI format for multi-cell scheduling.
Alternatively, the reference cell can be same as the cell A that is configured or determined in the SS set configuration of the SS set for the DCI format. Specifically, the configuration of the cell A includes the parameter nrofCandidates which configures the number of PDCCH candidates for the SS set with the DCI format for multi-cell scheduling.

If this DCI format has a DCI size that is different from other DCI format(s) for the reference cell, the counter of the number of DCI sizes for the reference cell is increased by 1.

In another embodiment, the DCI size budget of each serving cell can be maintained, i.e., (4, 3) which is same as existing NR. A DCI format for multi-cell scheduling is counted toward each of the multiple cells scheduled by the DCI format. For a cell that can be scheduled by a DCI format for multi-cell scheduling, the DCI format can be counted as ½ or 1/YDCI size in the counting of DCI sizes of the cell. Y is the maximum number of cells that can be scheduled by the DCI format. Alternatively, Y can be the maximum number of cells that are configured for multi-cell scheduling. Note that gNB may only configure a subset of cells which can be scheduled by the DCI format for multi-cell scheduling.

In this scheme, for a DCI format for multi-cell scheduling that can schedule Y>=2 cells, the total number of the DCI format counted across the multiple cells that can be scheduled by the DCI format is Y/2 DCI size (½ per cell*Y cells) or 1 DCI size (1/Y per cell*Y cells), thus the DCI size of the DCI format is not undercounted for a UE. If a DCI format for single-cell scheduling and a DCI format for multi-cell scheduling have the same DCI size for a cell, the DCI size is counted for the cell assuming the DCI format for single-cell scheduling.

In one example, in FIG. 7, the DCI format scheduling CC0/1/2 is respectively counted as ½ DCI size in the counting of DCI sizes of CC0/1/2. Further, the DCI format scheduling CC3/4 is respectively counted as ½ DCI size in the counting of DCI sizes of CC3/4.

In another example, in FIG. 7, if there exists a DCI format scheduling PDSCH transmission on CC0/1/2 and a DCI format scheduling PUSCH transmission on CC0/1/2, the two DCI formats are counted as 1 DCI size in the counting of DCI sizes of CC0/1/2. Further, if there exists a DCI format scheduling PDSCH transmission on CC3/4 and a DCI format scheduling PUSCH transmission on CC3/4, the two DCI formats are counted as 1 DCI size in the counting of DCI sizes of CC3/4. In this example, since the two DCI format for multi-cell scheduling are only counted as 1 DCI size for a cell, the remaining two DCI size can be used for single-cell PDSCH scheduling and single-cell PUSCH scheduling, e.g., DCI format 0_1/1_1 for the cell.

In one embodiment, the DCI format for multi-cell scheduling is DCI format 0_1 or 1_1. If the number of sizes of DCI format for a cell exceeds the maximum numbers (M, N) of the cell, DCI size alignment is performed until the resulting number of DCI sizes do not exceed (M, N). For example, the DCI size alignment in Section 7.3.1.0 of TS 38.212 can be reused.

In one embodiment, the DCI format for multi-cell scheduling is DCI format 0_3 or 1_3. If the number of sizes of DCI format for a cell exceeds the maximum numbers (M, N) of the cell, DCI size alignment is performed until the resulting number of DCI sizes do not exceed (M, N).

In one option, UE may not expect that the number of DCI sizes exceed the maximum numbers (M, N) of a cell after doing the DCI size alignment in Section 7.3.1.0 of TS 38.212. In other words, UE does not perform DCI size alignment between DCI format 0_3/1_3 with another DCI format. For example, (M, N)=(4,3) as existing NR, and UE does not expect the number of DCI sizes excluding DCI format 0_3/1_3 to exceed the maximum numbers (M-N′, N-N′) of a cell after doing the DCI size alignment in Section 7.3.1.0 of TS 38.212, where N′ is the number of DCI size for DCI format 0_3/1_3, and UE does not perform DCI size alignment between DCI format 0_3/1_3 with another DCI format.

In another option, (M, N)=(4,3) as existing NR, and UE does not expect the number of DCI sizes excluding DCI format 0_3/1_3 to exceed the maximum numbers (M, N) of a cell after doing the DCI size alignment in Section 7.3.1.0 of TS 38.212, but the number of DCI size including DCI format 0_3/1_3 can exceed (4,3), and UE does not perform DCI size alignment between DCI format 0_3/1_3 with another DCI format.

In another option, if the number of DCI sizes exceeds the maximum numbers (M, N) of a cell after doing the DCI size alignment in Section 7.3.1.0 of TS 38.212, the sizes of DCI format 0_3 and 1_3 are adjusted for alignment. For example:

Step 4D: (following the procedure for size alignment in Section 7.3.1.0 of TS 38.212)
If the total number of different DCI sizes configured to monitor is more than M for the cell after applying the above steps, or if the total number of different DCI sizes with C-RNTI configured to monitor is more than N for the cell after applying the above steps
If the number of information bits in the DCI format 0_3 prior to padding is less than the payload size of the DCI format 1_3 for scheduling the same serving cell, a number of zero padding bits are generated for the DCI format 0_3 until the payload size equals that of the DCI format 1_3.
If the number of information bits in the DCI format 1_3 prior to padding is less than the payload size of the DCI format 0_3 for scheduling the same serving cell, zeros shall be appended to the DCI format 1_3 until the payload size equals that of the DCI format 0_3.

In another option, if the number of DCI sizes still exceeds the maximum numbers (M, N) of a cell after doing the DCI size alignment in Section 7.3.1.0 of TS 38.212 and the size alignment of DCI format 0_3 and 1_3, the sizes of DCI format 0_1, 1_1, 0_3 & 1_3 are adjusted for alignment. For example, if DCI format 0_3/1_3 for multi-cell scheduling from the scheduling cell is considered as one DCI format of one cell, and after doing the DCI size alignment in Section 7.3.1.0 of TS 38.212, the DCI format size budget on the one cell still exceeds (M, N), UE may perform bit size alignment for DCI format 0_1, 1_1, 0_3 & 1_3.

In another option, if the number of DCI sizes still exceeds the maximum numbers (M, N) of a cell after doing the DCI size alignment in Section 7.3.1.0 of TS 38.212 and the size alignment of DCI format 0_3 and 1_3, the sizes of DCI format 0_2, 1_2, 0_3 & 1_3 are adjusted for alignment.

In another option, if the number of DCI sizes still exceeds the maximum numbers (M, N) of a cell after doing the DCI size alignment in Section 7.3.1.0 of TS 38.212 and the size alignment of DCI format 0_3 and 1_3, the sizes of DCI format 0_1, 1_1, 0_2 & 1_2 are adjusted for alignment.

In the above options, for size alignment of a DCI format for single-cell scheduling and a DCI format for multi-cell scheduling, the size of the DCI format for single-cell scheduling may be changed to align with the size of the DCI format for multi-cell scheduling.

In another option, if the number of DCI sizes still exceeds the maximum numbers (M, N) of a cell after doing the DCI size alignment in Section 7.3.1.0 of TS 38.212 and the size alignment of DCI format 0_3 and 1_3, the sizes of DCI format 0_3 & 1_3 and a DCI format 2_x/3_x/4_x are adjusted for alignment, where DCI format 2_x can be any DCI format 2_0, 2_1, 2_2, 2_3, 2_4, 2_5, 2_6, 2_7 or new DCI format 2 series, DCI format 3_x can be any DCI format 3_0, 3_1, or new DCI format 3 series, DCI format 4_x can be any DCI format 4_0, 4_1, 4_2, or new DCI format 4 series.

In another embodiment, if multiple DCI formats for multi-cell scheduling are configured respectively for PDSCH or PUSCH scheduling, if size alignment needs to be performed, the sizes of a DCI format for multi-cell PDSCH scheduling and a DCI format for multi-cell PUSCH scheduling are adjusted for alignment. In one option, the pairing of the DCI format for multi-cell PDSCH scheduling and the DCI format for multi-cell PUSCH scheduling can be configured by high layer signalling or determined by a predefined rule, e.g., the same set of cells can be scheduled by the two DCI formats.

In another embodiment, if multiple DCI formats for multi-cell scheduling are configured respectively for PDSCH or PUSCH scheduling, if size alignment needs to be performed, the sizes of two or more DCI formats for multi-cell PDSCH scheduling can be adjusted for alignment. Similarly, the sizes of two or more DCI formats for multi-cell PUSCH scheduling can be adjusted for alignment. The pairing of the two or more DCI formats for multi-cell PDSCH or PUSCH scheduling can be configured by high layer signalling.

In another embodiment, if multiple DCI formats for multi-cell scheduling are configured respectively for PDSCH or PUSCH scheduling, if size alignment needs to be performed, the sizes of two or more DCI formats for multi-cell scheduling can be adjusted for alignment. The two or more DCI formats may be for PDSCH scheduling only or for PUSCH scheduling only. Alternatively, the two or more DCI formats may include a DCI format for PDSCH scheduling and a DCI format for PUSCH scheduling. The two or more DCI formats for multi-cell scheduling for size alignment can be configured by high layer signalling.

In another embodiment, if the DCI size budget of a cell is increased when multi-cell scheduling is configured from the cell (scheduling cell) or for the cell (scheduled cell), UE may not expect that the number of DCI sizes exceeds the maximum numbers (M, N) of the cell after doing the DCI size alignment in Section 7.3.1.0 of TS 38.212.

In another embodiment, if the DCI size budget of the scheduling cell is increased when multi-cell scheduling is configured from the cell or for the cell, UE may not expect that the number of DCI sizes exceeds the maximum numbers (M, N) of the cell after doing the DCI size alignment in Section 7.3.1.0 of TS 38.212 except for Step 4C.

In another embodiment, if the DCI size budget of the scheduling cell is increased when multi-cell scheduling is configured from the cell or for the cell, UE may not expect that the number of DCI sizes exceeds the maximum numbers (M, N) of the cell after doing the DCI size alignment in Section 7.3.1.0 of TS 38.212 except for Step 4B & 4C.

In another embodiment, if the DCI size budget of the scheduling cell is increased when multi-cell scheduling is configured from the cell or for the cell, UE may not expect that the number of DCI sizes exceeds the maximum numbers (M, N) of the cell after doing the DCI size alignment in Section 7.3.1.0 of TS 38.212 except for Step 4.

### Maximum Numbers of Monitored PDCCH Candidates and Non-Overlapped CCEs

In NR operation, the UE is capable to decode a maximum number of M_{PDCCH}^{max,TU,μ} monitored PDCCH candidates or a maximum number of C_{PDCCH}^{max,TU,μ} non-overlapped CCEs in a time unit (TU) for a scheduled cell that is configured with a scheduling cell with SCS configuration μ. Further, another limit M_{PDCCH}^{total,TU,μ} or C_{PDCCH}^{total,TU,μ} in a TU applies to the scheduled cells that are configured with scheduling cells having same SCS configuration μ. Note: the scheduling cell is a scheduled cell scheduled by itself.

In one embodiment, the maximum number of monitored PDCCH candidates M_{PDCCH}^{max,TU,μ} or non-overlapped CCEs C_{PDCCH}^{max,TU,μ} for a cell can be adjusted considering multi-cell scheduling. For example, if the DCI format for multi-cell scheduling is counted toward a cell, M_{PDCCH}^{max,TU,μ} or C_{PDCCH}^{max,TU,μ} of the cell may be increased. Otherwise, M_{PDCCH}^{max,TU,μ} or C_{PDCCH}^{max,TU,μ} of the cell may be decreased.

In one option, if a maximum of X cells can be scheduled by the scheduling cell using multi-cell scheduling, M_{PDCCH}^{max,TU,μ} or C_{PDCCH}^{max,TU,μ} for the scheduling cell can be scaled by X times. In this option, the PDCCH candidates or non-overlapped CCEs for a DCI format for single-cell or multi-cell scheduling that are transmitted on the scheduling cell are counted to the scheduling cell.

In another option, M_{PDCCH}^{max,TU,μ} or C_{PDCCH}^{max,TU,μ} for a scheduling or scheduled cell can be configured by high layer signaling. Alternatively, the scaling factors sₘ, s_{c} to the existing maximum numbers M_{PDCCH}^{max,TU,μ} or C_{PDCCH}^{max,TU,μ} for a scheduling or scheduled cell can be configured by high layer signaling, i.e. M_{PDCCH}^{max,TU,μ}=sₘ·M_{PDCCH}^{max,TU,μ}, C_{PDCCH}^{max,TU,μ}=s_{c}·C_{PDCCH}^{max,TU,μ}. sₘ, s_{c} may be separately configured, or sₘ=s_{c}. In this option, to count the number of PDCCH candidates or non-overlapped CCEs, a DCI format for multi-cell scheduling may be counted to a single cell for which M_{PDCCH}^{max,TU,μ} or C_{PDCCH}^{max,TU,μ} can be increased.

In yet another option, the value of M_{PDCCH}^{max,TU,μ} or C_{PDCCH}^{max,TU,μ} is not changed when multi-cell scheduling is configured. In this option, to count the number of PDCCH candidates or non-overlapped CCEs, a DCI format for multi-cell scheduling may be counted to a single cell or counted to each of the cells scheduled by the DCI format.

In one embodiment, to check the maximum number of monitored PDCCH candidates M_{PDCCH}^{max,TU,μ} or the maximum number of non-overlapped CCEs C_{PDCCH}^{total,TU,μ}, the number of monitored PDCCH candidates or non-overlapped CCEs of a PDCCH candidate with a DCI format for multi-cell scheduling from the scheduling cell should be handled specially.

In one option, for a DCI format for multi-cell scheduling from the scheduling cell, a PDCCH candidate with AL L of the DCI format is counted as one monitored PDCCH candidate or L non-overlapped CCEs repeatedly toward each cell that can be scheduled by the DCI format.

In another option, for a DCI format for multi-cell scheduling from the scheduling cell, a PDCCH candidate with AL L of the DCI format is counted as one monitored PDCCH candidate or L non-overlapped CCEs repeatedly toward each cell that can be scheduled by the DCI format and is not the scheduling cell.

In another option, for a DCI format for multi-cell scheduling from the scheduling cell, a PDCCH candidate with AL L of the DCI format is counted as Y monitored PDCCH candidates or L·Y non-overlapped CCEs of the scheduling cell only. Y is the maximum number of the cells that can be scheduled by the DCI format.

In another option, for a DCI format for multi-cell scheduling from the scheduling cell, a PDCCH candidate with AL L of the DCI format is counted as Y monitored PDCCH candidates or L·Y non-overlapped CCEs of a reference cell only. Y is the maximum number of the cells that can be scheduled by the DCI format. For example, the reference cell could be the cell with lowest cell index that can be scheduled by the DCI format.

In another option, for a DCI format for multi-cell scheduling from the scheduling cell, a PDCCH candidate with AL L of the DCI format is counted as one monitored PDCCH candidate or L non-overlapped CCEs of the scheduling cell only.

In another option, for a DCI format for multi-cell scheduling from the scheduling cell, a PDCCH candidate with AL L of the DCI format is counted as one monitored PDCCH candidate or L non-overlapped CCEs of a reference cell only.

In one example, the reference cell could be the cell with lowest cell index that can be scheduled by the DCI format.
In another example, the reference cell may be the cell with lowest index that can be configured or scheduled by the DCI format other than the scheduling cell.
In another example, if the scheduling cell can be scheduled by the DCI format, the reference cell is the scheduling cell. Otherwise, the reference cell can be a scheduled cell, e.g., the cell with lowest index that can be configured or scheduled by the DCI format.
In another example, the reference cell could be a scheduled cell that can be scheduled by the DCI format and is not the scheduling cell.
In another example, the reference cell can be configured by high layer signaling, e.g., in the configuration of CrossCarrierSchedulingConfig or SearchSpace.
In another example, if a SS set of the DCI format for multi-cell scheduling is configured on a cell X of the cells that can be scheduled by the DCI format, the reference cell can be the cell X. Note that cell X may be a cell that can be configured or scheduled by DCI format for multi-cell scheduling.
In another example, the reference cell can be same as the cell A that is configured or determined in the SS set configuration of the SS set for the DCI format. Specifically, the configuration of the cell A includes the parameter nrofCandidates which configures the number of PDCCH candidates for the SS set with the DCI format for multi-cell scheduling.

In another option, for a DCI format for multi-cell scheduling from the scheduling cell, a PDCCH candidate with AL L of the DCI format is split and counted as 1/Y monitored PDCCH candidate or L/Y non-overlapped CCEs of each cell that can be scheduled by the DCI format, where Y is the maximum number of the cells that can be scheduled by the DCI format.

In another option, for a DCI format for multi-cell scheduling from the scheduling cell, a PDCCH candidate with AL L of the DCI format is split and counted as 1/Y monitored PDCCH candidate or L/Y non-overlapped CCEs of each cell that can be scheduled by the DCI format and is not the scheduling cell, where Y is the maximum number of the cells that can be scheduled by the DCI format and are not the scheduling cell.

In one embodiment, to check the total number of monitored PDCCH candidates M_{PDCCH}^{total,TU,μ} or non-overlapped CCEs C_{PDCCH}^{total,TU,μ}, for a DCI format for multi-cell scheduling from the scheduling cell, a PDCCH candidate with AL L of the DCI format is counted as one monitored PDCCH candidate or L non-overlapped CCEs. In this embodiment, M_{PDCCH}^{total,TU,μ} or C_{PDCCH}^{total,TU,μ} can be determined by the existing formula for single-cell scheduling in TS38.213, clause 10.1.

In one embodiment, to check the total number of monitored PDCCH candidates M_{PDCCH}^{total,TU,μ} or non-overlapped CCEs C_{PDCCH}^{total,TU,μ}, for a DCI format for multi-cell scheduling from the scheduling cell, a PDCCH candidate with AL L of the DCI format is counted as Y monitored PDCCH candidates or L·Y non-overlapped CCEs, where Y is the maximum number of the cells that can be scheduled by the DCI format. In this embodiment, M_{PDCCH}^{total,TU,μ} or C_{PDCCH}^{total,TU,μ} can be determined by the existing formula for single-cell scheduling in TS38.213, clause 10.1.

In one embodiment, the existing mechanism to check the maximum numbers of monitored PDCCH candidates or non-overlapped CCEs is reused without considering the DCI format for multi-cell scheduling. In particular, the UE is not required to monitor more than M_{PDCCH}^{max,TU,μ} PDCCH candidates or C_{PDCCH}^{max,TU,μ} non-overlapped CCEs per cell, or more than M_{PDCCH}^{total,TU,μ} PDCCH candidates or more than C_{PDCCH}^{total,TU,μ} non-overlapped CCEs for a group of cells that are scheduled by the scheduling cells with same SCS μ, without considering any DCI format for multi-cell scheduling. In other words, the checking of M_{PDCCH}^{max,TU,μ}, C_{PDCCH}^{max,TU,μ}, M_{PDCCH}^{total,TU,μ} or C_{PDCCH}^{total,TU,μ} only apply to the DCI formats other than a DCI format for multi-cell scheduling, which can reuse the same procedure as existing procedure in TS 38.213. There is no limitation on the additional PDCCH candidates or non-overlapped CCEs caused by the monitoring of a DCI format for multi-cell scheduling.

In one embodiment, without considering any DCI format for multi-cell scheduling, the UE is not required to monitor more than M_{PDCCH}^{max,TU,μ} PDCCH candidates or C_{PDCCH}^{max,TU,μ} non-overlapped CCEs per cell, or more than M_{PDCCH}^{total,TU,μ} PDCCH candidates or more than C_{PDCCH}^{total,TU,μ} non-overlapped CCEs for a group of cells that are scheduled by the scheduling cells with same SCS μ. Then, considering all DCI formats for single-cell scheduling and multi-cell scheduling for the group of cells, the UE is not required to monitor more than M_{PDCCH}^{max,TU,μ} PDCCH candidates or more than C_{PDCCH}^{total,TU,μ} non-overlapped CCEs of the group of cells. In this embodiment, M_{PDCCH}^{total,TU,μ} or C_{PDCCH}^{total,TU,μ} can be determined by the existing formula for single-cell scheduling in TS38.213, clause 10.1.

In one embodiment, without considering any DCI format for multi-cell scheduling, the UE is not required to monitor more than M_{PDCCH}^{max,TU,μ} PDCCH candidates or C_{PDCCH}^{max,TU,μ} non-overlapped CCEs per cell. Then, considering all DCI formats for single-cell scheduling and multi-cell scheduling for the group of cells, the UE is not required to monitor more than M_{PDCCH}^{total,TU,μ} PDCCH candidates or more than C_{PDCCH}^{total,TU,μ} non-overlapped CCEs of a group of cells that are scheduled by the scheduling cells with same SCS μ. In this embodiment, M_{PDCCH}^{total,TU,μ} or C_{PDCCH}^{total,TU,μ} can be determined by the existing formula for single-cell scheduling in TS38.213, clause 10.1.

In one embodiment, for a DCI format for multi-cell scheduling, a subset of the cells that can be scheduled by the DCI format are determined, which commonly applies in the counting of DCI sizes for the cells or counting the numbers of monitored PDCCH candidates or non-overlapped CCEs for the cells. Specifically, if the DCI format has a different size for a cell in the subset, the number of DCI sizes of the cell is increased. For a cell not in the subset, the number of DCI sizes is not impacted by the DCI format. Corresponding to the DCI format, the numbers of monitored PDCCH candidates or non-overlapped CCEs for a cell in the subset is increased. For a cell not in the subset, the numbers of monitored PDCCH candidates or non-overlapped CCEs is not impacted by the DCI format. It is not precluded that the above subset may be used for other function/procedure too.

In one example, the DCI format may be only considered as a DCI format of the scheduling cell on which the DCI format is transmitted. In another example, the DCI format may be only considered as a DCI format of a cell that is scheduled by the DCI format. In another example, the DCI format may be only considered as a DCI format of each cell that can be scheduled by the DCI format. In another example, if a SS set of the DCI format is configured on a cell X of the cells that can be scheduled by the DCI format, the DCI format may be only considered as a DCI format of cell X. In another example, the DCI format may be only considered as a DCI format of the cell A that is configured or determined in the SS set configuration of the SS set for the DCI format. Specifically, the configuration of the cell A includes the parameter nrofCandidates which: configures the number of PDCCH candidates for the SS set.

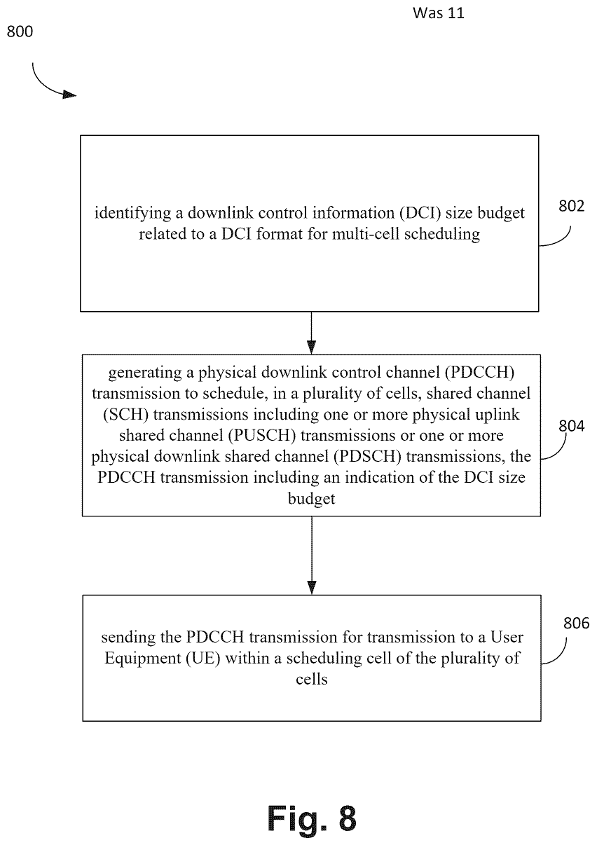

FIG. 8 depicts a process 800 according to a first embodiment. Process 800 includes, at operation 802, identifying a downlink control information (DCI) size budget related to a DCI format for multi-cell scheduling; at operation 804, generating a physical downlink control channel (PDCCH) transmission to schedule, in a plurality of cells, shared channel (SCH) transmissions including one or more physical uplink shared channel (PUSCH) transmissions or one or more physical downlink shared channel (PDSCH) transmissions, the PDCCH transmission including an indication of the DCI size budget; and at operation 806, encoding the PDCCH transmission for transmission to a User Equipment (UE) within a scheduling cell of the plurality of cells.

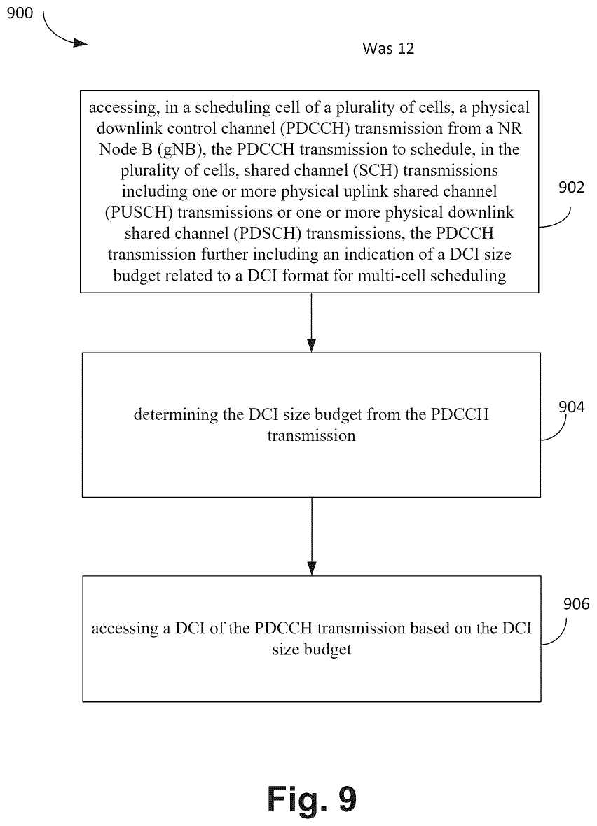

FIG. 9 depicts a process 900 according to a first embodiment. Process 900 includes, at operation 902, accessing, in a scheduling cell of a plurality of cells, a physical downlink control channel (PDCCH) transmission from a NR Node B (gNB), the PDCCH transmission to schedule, in the plurality of cells, shared channel (SCH) transmissions including one or more physical uplink shared channel (PUSCH) transmissions or one or more physical downlink shared channel (PDSCH) transmissions, the PDCCH transmission further including an indication of a DCI size budget related to a DCI format for multi-cell scheduling; at operation 904, determining the DCI size budget from the PDCCH transmission; and at operation 906, accessing a DCI of the PDCCH transmission based on the DCI size budget.

### Examples

Example 1 includes an apparatus of a New Radio (NR) Node B (gNB) including: one or more processors to perform operations including: identifying a downlink control information (DCI) size budget related to a DCI format for multi-cell scheduling; generating a physical downlink control channel (PDCCH) transmission to schedule, in a plurality of cells, shared channel (SCH) transmissions, the PDCCH transmission including an indication of the DCI size budget; and encoding the PDCCH transmission for transmission to a User Equipment (UE) within a scheduling cell of the plurality of cells; and a memory to store at least one of the DCI size budget or the PDCCH.

Example 2 includes the subject matter of Example 1, wherein the DCI size budget may have a value M for a maximum DCI size budget for all DCI formats, and a value N for DCI formats scrambled by C-RNTI for a serving cell, wherein M=4 and N=3.

Example 3 includes the subject matter of any one of Examples 1-2, wherein the DCI format for multi-cell scheduling corresponds to one of format 0_3 or 1_3.

Example 4 includes the subject matter of any one of Examples 1-2, the operations further including: generating a downlink control information (DCI) configuration message to the UE to configure the UE to monitor, on the scheduling cell, for the DCI format for multi-cell scheduling, the DCI format for multi-cell scheduling corresponding to one DCI format of only a reference cell; and encoding the DCI configuration message for transmission to the UE.

Example 5 includes the subject matter of Example 4, wherein the DCI configuration message to the UE further includes information for search space (SS) set configuration of a SS set of a cell A of the plurality of cells, the information for SS set configuration including a number of candidates (nrofcandidates) parameter corresponding to a number of PDCCH candidates with the DCI format for multi-cell scheduling that are to be monitored by the UE on the scheduling cell, wherein the reference cell corresponds to cell A.

Example 6 includes the subject matter of Example 1, wherein: the operations further include generating, and encoding for transmission to the UE, a downlink control information (DCI) configuration message that includes information for search space (SS) set configuration of a SS set of a reference cell, the information for SS set configuration including a number of candidates (nrofcandidates) parameter corresponding to a number of PDCCH candidates with the DCI format for multi-cell scheduling that are to be monitored by the UE within the reference cell; the scheduling cell has a subcarrier spacing μ; and the nrofcandidates parameter is based on a capability of the UE including one of: a maximum number M_{PDCCH}^{max,TU,μ} of PDCCH candidates that the UE is capable of monitoring within a time unit (TU) for the reference cell; or a maximum number C_{PDCCH}^{max,TU,μ} of non-overlapped control channel elements (CCEs) that the UE is capable of monitoring within TU for the reference cell.

Example 7 includes the subject matter of Example 6, the operations further including counting the number of PDCCH candidates or a number of the non-overlapped CCEs corresponding to the DCI format for multi-cell scheduling to only the reference cell.

Example 8 includes the subject matter of Example 6, the operations further including counting, to only the reference cell, a PDCCH candidate with an aggregation level (AL) L, where the PDCCH candidate is based on the DCI format for multi-cell scheduling, as one monitored PDCCH candidate or L non-overlapped CCEs.

Example 9 includes the subject matter of Example 7, wherein the plurality of cells correspond to a subset of cells that can be scheduled by the DCI format for multi-cell scheduling, and wherein counting the DCI size budget, the number of PDCCH candidates or the number of non-overlapped CCEs corresponds to counting for the plurality of cells to the reference cell.

Example 10 includes the subject matter of any one of Examples 1-9, further including a Radio Frequency (RF) interface, and a front end module coupled to the RF interface.

Example 11 includes the subject matter of Example 10, further including one or more antennas coupled to the front end module to transmit the PDCCH.

Example 12 includes a method to be performed at an apparatus of a New Radio (NR) Node B (gNB), the method including: identifying a downlink control information (DCI) size budget related to a DCI format for multi-cell scheduling; generating a physical downlink control channel (PDCCH) transmission to schedule, in a plurality of cells, shared channel (SCH) transmissions, the PDCCH transmission including an indication of the DCI size budget; and encoding the PDCCH transmission for transmission to a User Equipment (UE) within a scheduling cell of the plurality of cells.

Example 13 includes the subject matter of Example 12, wherein the DCI size budget may have a value M for a maximum DCI size budget for all DCI formats, and a value N for DCI formats scrambled by C-RNTI for a serving cell, wherein M=4 and N=3.

Example 14 includes the subject matter of any one of Examples 12-13, wherein the DCI format for multi-cell scheduling corresponds to one of format 0_3 or 1_3.

Example 15 includes the subject matter of any one of Examples 12-14, further including: generating a downlink control information (DCI) configuration message to the UE to configure the UE to monitor, on the scheduling cell, for the DCI format for multi-cell scheduling, the DCI format for multi-cell scheduling corresponding to one DCI format of only a reference cell; and encoding the DCI configuration message for transmission to the UE.

Example 16 includes the subject matter of Example 15, wherein the DCI configuration message to the UE further includes information for search space (SS) set configuration of a SS set of a cell A of the plurality of cells, the information for SS set configuration including a number of candidates (nrofcandidates) parameter corresponding to a number of PDCCH candidates with the DCI format for multi-cell scheduling that are to be monitored by the UE on the scheduling cell, wherein the reference cell corresponds to cell A.

Example 17 includes the subject matter of Example 12, wherein: the method further includes generating, and encoding for transmission to the UE, a downlink control information (DCI) configuration message that includes information for search space (SS) set configuration of a SS set of a reference cell, the information for SS set configuration including a number of candidates (nrofcandidates) parameter corresponding to a number of PDCCH candidates with the DCI format for multi-cell scheduling that are to be monitored by the UE within the reference cell; the scheduling cell has a subcarrier spacing μ; and the nrofcandidates parameter is based on a capability of the UE including one of: a maximum number M_{PDCCH}^{max,TU,μ} of PDCCH candidates that the UE is capable of monitoring within a time unit (TU) for the reference cell; or a maximum number C_{PDCCH}^{max,TU,μ} of non-overlapped control channel elements (CCEs) that the UE is capable of monitoring within TU for the reference cell.

Example 18 includes the subject matter of Example 17, further including counting the number of PDCCH candidates or a number of the non-overlapped CCEs corresponding to the DCI format for multi-cell scheduling to only the reference cell.

Example 19 includes the subject matter of Example 17, further including counting, to only the reference cell, a PDCCH candidate with an aggregation level (AL) L, where the PDCCH candidate is based on the DCI format for multi-cell scheduling, as one monitored PDCCH candidate or L non-overlapped CCEs.

Example 20 includes the subject matter of Example 18, wherein the plurality of cells correspond to a subset of cells that can be scheduled by the DCI format for multi-cell scheduling, and wherein counting the DCI size budget, the number of PDCCH candidates or the number of non-overlapped CCEs corresponds to counting for the plurality of cells to the reference cell.

Example 21 includes one or more non-transitory computer-readable media comprising instructions to cause one or more processors of a New Radio (NR) Node B (gNB), upon execution of the instructions, to perform operations including: identifying a downlink control information (DCI) size budget related to a DCI format for multi-cell scheduling; generating a physical downlink control channel (PDCCH) transmission to schedule, in a plurality of cells, shared channel (SCH) transmissions, the PDCCH transmission including an indication of the DCI size budget; and encoding the PDCCH transmission for transmission to a User Equipment (UE) within a scheduling cell of the plurality of cells.

Example 22 includes the subject matter of Example 21, wherein the DCI size budget may have a value M for a maximum DCI size budget for all DCI formats, and a value N for DCI formats scrambled by C-RNTI for a serving cell, wherein M=4 and N=3.

Example 23 includes the subject matter of any one of Examples 21-22, wherein the DCI format for multi-cell scheduling corresponds to one of format 0_3 or 1_3.

Example 24 includes the subject matter of any one of Examples 21-23, the operations further including: generating a downlink control information (DCI) configuration message to the UE to configure the UE to monitor, on the scheduling cell, for the DCI format for multi-cell scheduling, the DCI format for multi-cell scheduling corresponding to one DCI format of only a reference cell; and encoding the DCI configuration message for transmission to the UE.

Example 25 includes the subject matter of Example 24, wherein the DCI configuration message to the UE further includes information for search space (SS) set configuration of a SS set of a cell A of the plurality of cells, the information for SS set configuration including a number of candidates (nrofcandidates) parameter corresponding to a number of PDCCH candidates with the DCI format for multi-cell scheduling that are to be monitored by the UE on the scheduling cell, wherein the reference cell corresponds to cell A.

Example 26 includes the subject matter of Example 21, wherein: the operations further include generating, and encoding for transmission to the UE, a downlink control information (DCI) configuration message that includes information for search space (SS) set configuration of a SS set of a reference cell, the information for SS set configuration including a number of candidates (nrofcandidates) parameter corresponding to a number of PDCCH candidates with the DCI format for multi-cell scheduling that are to be monitored by the UE within the reference cell; the scheduling cell has a subcarrier spacing μ; and the nrofcandidates parameter is based on a capability of the UE including one of: a maximum number M_{PDCCH}^{max,TU,μ} of PDCCH candidates that the UE is capable of monitoring within a time unit (TU) for the reference cell; or a maximum number C_{PDCCH}^{max,TU,μ} of non-overlapped control channel elements (CCEs) that the UE is capable of monitoring within TU for the reference cell.

Example 27 includes the subject matter of Example 26, the operations further including counting the number of PDCCH candidates or a number of the non-overlapped CCEs corresponding to the DCI format for multi-cell scheduling to only the reference cell.

Example 28 includes the subject matter of Example 26, the operations further including counting, to only the reference cell, a PDCCH candidate with an aggregation level (AL) L, where the PDCCH candidate is based on the DCI format for multi-cell scheduling, as one monitored PDCCH candidate or L non-overlapped CCEs.

Example 29 includes the subject matter of Example 27, wherein the plurality of cells correspond to a subset of cells that can be scheduled by the DCI format for multi-cell scheduling, and wherein counting the DCI size budget, the number of PDCCH candidates or the number of non-overlapped CCEs corresponds to counting for the plurality of cells to the reference cell.

Example 30 includes an apparatus of a New Radio (NR) User Equipment (UE) including: one or more processors to perform operations including: accessing, in a scheduling cell of a plurality of cells, a physical downlink control channel (PDCCH) transmission from a NR Node B (gNB), the PDCCH transmission to schedule, in the plurality of cells, shared channel (SCH) transmissions, the PDCCH transmission further including an indication of a DCI size budget related to a DCI format for multi-cell scheduling; determining the DCI size budget from the PDCCH transmission; and accessing a DCI of the PDCCH transmission based on the DCI size budget; and a memory to store the DCI size budget.

Example 31 includes the subject matter of Example 30, wherein the DCI size budget may have a value M for a maximum DCI size budget for all DCI formats, and a value N for DCI formats scrambled by C-RNTI for a serving cell, wherein M=4 and N=3.

Example 32 includes the subject matter of any one of Examples 30-31, wherein the DCI format for multi-cell scheduling corresponds to one of format 0_3 or 1_3.

Example 33 includes the subject matter of any one of Examples 30-32, the operations further including: accessing a downlink control information (DCI) configuration message from the gNB; and based on the DCI configuration message, causing the UE to monitor, on the scheduling cell, for the DCI format for multi-cell scheduling, the DCI format for multi-cell scheduling corresponding to one DCI format of only a reference cell.

Example 34 includes the subject matter of Example 33, wherein the DCI configuration message further includes information for search space (SS) set configuration of a SS set of a cell A of the plurality of cells, the information for SS set configuration including a number of candidates (nrofcandidates) parameter corresponding to a number of PDCCH candidates with the DCI format for multi-cell scheduling that are to be monitored by the UE on the scheduling cell, wherein the reference cell corresponds to cell A.

Example 35 includes the subject matter of Example 30, wherein: the operations further include: accessing a downlink control information (DCI) configuration message from the gNB, the DCI configuration message including information for search space (SS) set configuration of a SS set of a reference cell, the information for SS set configuration including a number of candidates (nrofcandidates) parameter corresponding to a number of PDCCH candidates with the DCI format for multi-cell scheduling that are to be monitored by the UE within the reference cell; and causing configuration of the UE based on the DCI configuration message; the scheduling cell has a subcarrier spacing μ; and the nrofcandidates parameter is based on a capability of the UE including one of: a maximum number M_{PDCCH}^{max,TU,μ} of PDCCH candidates that the UE is capable of monitoring within a time unit (TU) for the reference cell; or a maximum number C_{PDCCH}^{max,TU,μ} of non-overlapped control channel elements (CCEs) that the UE is capable of monitoring within TU for the reference cell.

Example 36 includes the subject matter of Example 35, wherein the number of PDCCH candidates or a number of the non-overlapped CCEs corresponding to the DCI format for multi-cell scheduling are based on only the reference cell.

Example 37 includes the subject matter of Example 35, wherein a count of a PDCCH candidate with an aggregation level (AL) L, where the PDCCH candidate is based on the DCI format for multi-cell scheduling, corresponds, for only the reference cell, to one monitored PDCCH candidate or L non-overlapped CCEs.

Example 38 includes the subject matter of Example 31, the operations further including, in response to a determination that a number of DCI sizes for the DCI format for multi-cell scheduling exceeds the maximum number M or maximum number N for the serving cell, performing DCI size alignment until a resulting number of DCI sizes for the DCI format for multi-cell scheduling do not exceeds the maximum numbers M and N.

Example 39 includes the subject matter of Example 38, the operations further including, after performing size alignment, not expecting the number of DCI sizes for the DCI format for multi-cell scheduling to the maximum numbers M and N for the serving cell.

Example 40 includes the subject matter of Example 38, the operations further including, after performing size alignment, adjusting sizes of DCI format 0_3 or DCI format 1_3 for alignment in response to a determination that at least one of the number of DCI sizes for the DCI format for multi-cell scheduling exceeds the maximum number M or the number of DCI sizes with C-RNTI for the DCI format for multi-cell scheduling exceeds the maximum number N, adjusting including, in response to a further determination that a number of information bits in the DCI format 0_3 prior to padding is less than a payload size of the DCI format 1_3 for scheduling the serving cell, generating a number of zero padding bits for the DCI format 0_3 until a payload size of the DCI format 0_3 equals the payload size of the DCI format 1_3.

Example 41 includes the subject matter of Example 38, the operations further including, after performing size alignment, adjusting sizes of DCI format 0_3 or DCI format 1_3 for alignment in response to a determination that at least one of the number of DCI sizes for the DCI format for multi-cell scheduling exceeds the maximum number M or the number of DCI sizes with C-RNTI for the DCI format for multi-cell scheduling exceeds the maximum number N, adjusting including, in response to a further determination that a number of information bits in the DCI format 1_3 prior to padding is less than a payload size of the DCI format 0_3 for scheduling the serving cell, generating a number of zero padding bits for the DCI format 1_3 until a payload size of the DCI format 0_3 equals the payload size of the DCI format 0_3.

Example 42 includes the subject matter of any one of Examples 30-41, further including a Radio Frequency (RF) interface, and a front end module coupled to the RF interface.

Example 43 includes the subject matter of Example 42, further including one or more antennas coupled to the front end module to transmit the PDCCH.

Example 44 includes a method to be performed at an apparatus of a New Radio (NR) User Equipment (UE), the method including: accessing, in a scheduling cell of a plurality of cells, a physical downlink control channel (PDCCH) transmission from a NR Node B (gNB), the PDCCH transmission to schedule, in the plurality of cells, shared channel (SCH) transmissions, the PDCCH transmission further including an indication of a DCI size budget related to a DCI format for multi-cell scheduling; determining the DCI size budget from the PDCCH transmission; and accessing a DCI of the PDCCH transmission based on the DCI size budget.

Example 45 includes the subject matter of Example 44, wherein the DCI size budget may have a value M for a maximum DCI size budget for all DCI formats, and a value N for DCI formats scrambled by C-RNTI for a serving cell, wherein M=4 and N=3.

Example 46 includes the subject matter of any one of Examples 44-45, wherein the DCI format for multi-cell scheduling corresponds to one of format 0_3 or 1_3.

Example 47 includes the subject matter of any one of Examples 44-46, the method further including: accessing a downlink control information (DCI) configuration message from the gNB; and based on the DCI configuration message, causing the UE to monitor, on the scheduling cell, for the DCI format for multi-cell scheduling, the DCI format for multi-cell scheduling corresponding to one DCI format of only a reference cell.

Example 48 includes the subject matter of Example 47, wherein the DCI configuration message further includes information for search space (SS) set configuration of a SS set of a cell A of the plurality of cells, the information for SS set configuration including a number of candidates (nrofcandidates) parameter corresponding to a number of PDCCH candidates with the DCI format for multi-cell scheduling that are to be monitored by the UE on the scheduling cell, wherein the reference cell corresponds to cell A.

Example 49 includes the subject matter of Example 44, further including: accessing a downlink control information (DCI) configuration message from the gNB, the DCI configuration message including information for search space (SS) set configuration of a SS set of a reference cell, the information for SS set configuration including a number of candidates (nrofcandidates) parameter corresponding to a number of PDCCH candidates with the DCI format for multi-cell scheduling that are to be monitored by the UE within the reference cell; causing configuration of the UE based on the DCI configuration message, wherein: the scheduling cell has a subcarrier spacing μ; and the nrofcandidates parameter is based on a capability of the UE including one of: a maximum number M_{PDCCH}^{max,TU,μ} of PDCCH candidates that the UE is capable of monitoring within a time unit (TU) for the reference cell; or a maximum number C_{PDCCH}^{max,TU,μ} of non-overlapped control channel elements (CCEs) that the UE is capable of monitoring within TU for the reference cell.

Example 50 includes the subject matter of Example 49, wherein the number of PDCCH candidates or a number of the non-overlapped CCEs corresponding to the DCI format for multi-cell scheduling are based on only the reference cell.

Example 51 includes the subject matter of Example 49, wherein a count of a PDCCH candidate with an aggregation level (AL) L, where the PDCCH candidate is based on the DCI format for multi-cell scheduling, corresponds, for only the reference cell, to one monitored PDCCH candidate or L non-overlapped CCEs.

Example 52 includes the subject matter of Example 45, further including, in response to a determination that a number of DCI sizes for the DCI format for multi-cell scheduling exceeds the maximum numbers M and N for the serving cell, performing DCI size alignment until a resulting number of DCI sizes for the DCI format for multi-cell scheduling do not exceeds the maximum numbers M and N.

Example 53 includes the subject matter of Example 52, further including, after performing size alignment, not expecting the number of DCI sizes for the DCI format for multi-cell scheduling to the maximum numbers M and N for the serving cell.

Example 54 includes the subject matter of Example 52, further including, after performing size alignment, adjusting sizes of DCI format 0_3 or DCI format 1_3 for alignment in response to a determination that at least one of the number of DCI sizes for the DCI format for multi-cell scheduling exceeds the maximum number M or the number of DCI sizes with C-RNTI for the DCI format for multi-cell scheduling exceeds the maximum number N, adjusting including, in response to a further determination that a number of information bits in the DCI format 0_3 prior to padding is less than a payload size of the DCI format 1_3 for scheduling the serving cell, generating a number of zero padding bits for the DCI format 0_3 until a payload size of the DCI format 0_3 equals the payload size of the DCI format 1_3.

Example 55 includes the subject matter of Example 52, further including, after performing size alignment, adjusting sizes of DCI format 0_3 or DCI format 1_3 for alignment in response to a determination that at least one of the number of DCI sizes for the DCI format for multi-cell scheduling exceeds the maximum number M or the number of DCI sizes with C-RNTI for the DCI format for multi-cell scheduling exceeds the maximum number N, adjusting including, in response to a further determination that a number of information bits in the DCI format 1_3 prior to padding is less than a payload size of the DCI format 0_3 for scheduling the serving cell, generating a number of zero padding bits for the DCI format 1_3 until a payload size of the DCI format 0_3 equals the payload size of the DCI format 0_3.

Example 56 includes one or more non-transitory computer-readable media comprising instructions to cause one or more processors of a New Radio (NR) User Equipment (UE), upon execution of the instructions, to perform operations including: accessing, in a scheduling cell of a plurality of cells, a physical downlink control channel (PDCCH) transmission from a NR Node B (gNB), the PDCCH transmission to schedule, in the plurality of cells, shared channel (SCH) transmissions, the PDCCH transmission further including an indication of a DCI size budget related to a DCI format for multi-cell scheduling; determining the DCI size budget from the PDCCH transmission; and accessing a DCI of the PDCCH transmission based on the DCI size budget.

Example 57 includes the subject matter of Example 56, wherein the DCI size budget may have a value M for a maximum DCI size budget for all DCI formats, and a value N for DCI formats scrambled by C-RNTI for a serving cell, wherein M=4 and N=3.

Example 58 includes the subject matter of any one of Examples 56-57, wherein the DCI format for multi-cell scheduling corresponds to one of format 0_3 or 1_3.

Example 59 includes the subject matter of any one of Examples 56-58, the operations further including: accessing a downlink control information (DCI) configuration message from the gNB; and based on the DCI configuration message, causing the UE to monitor, on the scheduling cell, for the DCI format for multi-cell scheduling, the DCI format for multi-cell scheduling corresponding to one DCI format of only a reference cell.

Example 60 includes the subject matter of Example 59, wherein the DCI configuration message further includes information for search space (SS) set configuration of a SS set of a cell A of the plurality of cells, the information for SS set configuration including a number of candidates (nrofcandidates) parameter corresponding to a number of PDCCH candidates with the DCI format for multi-cell scheduling that are to be monitored by the UE on the scheduling cell, wherein the reference cell corresponds to cell A.

Example 61 includes the subject matter of Example 56, wherein: the operations further include: accessing a downlink control information (DCI) configuration message from the gNB, the DCI configuration message including information for search space (SS) set configuration of a SS set of a reference cell, the information for SS set configuration including a number of candidates (nrofcandidates) parameter corresponding to a number of PDCCH candidates with the DCI format for multi-cell scheduling that are to be monitored by the UE within the reference cell; and causing configuration of the UE based on the DCI configuration message; the scheduling cell has a subcarrier spacing μ; and the nrofcandidates parameter is based on a capability of the UE including one of: a maximum number M_{PDCCH}^{max,TU,μ} of PDCCH candidates that the UE is capable of monitoring within a time unit (TU) for the reference cell; or a maximum number C_{PDCCH}^{max,TU,μ} of non-overlapped control channel elements (CCEs) that the UE is capable of monitoring within TU for the reference cell.

Example 62 includes the subject matter of Example 61, wherein the number of PDCCH candidates or a number of the non-overlapped CCEs corresponding to the DCI format for multi-cell scheduling are based on only the reference cell.

Example 63 includes the subject matter of Example 61, wherein a count of a PDCCH candidate with an aggregation level (AL) L, where the PDCCH candidate is based on the DCI format for multi-cell scheduling, corresponds, for only the reference cell, to one monitored PDCCH candidate or L non-overlapped CCEs.

Example 64 includes the subject matter of Example 57, the operations further including, in response to a determination that a number of DCI sizes for the DCI format for multi-cell scheduling exceeds the maximum number M or maximum number N for the serving cell, performing DCI size alignment until a resulting number of DCI sizes for the DCI format for multi-cell scheduling do not exceeds the maximum numbers M and N.

Example 65 includes the subject matter of Example 64, the operations further including, after performing size alignment, not expecting the number of DCI sizes for the DCI format for multi-cell scheduling to the maximum numbers M and N for the serving cell.

Example 66 includes the subject matter of Example 64, the operations further including, after performing size alignment, adjusting sizes of DCI format 0_3 or DCI format 1_3 for alignment in response to a determination that at least one of the number of DCI sizes for the DCI format for multi-cell scheduling exceeds the maximum number M or the number of DCI sizes with C-RNTI for the DCI format for multi-cell scheduling exceeds the maximum number N, adjusting including, in response to a further determination that a number of information bits in the DCI format 0_3 prior to padding is less than a payload size of the DCI format 1_3 for scheduling the serving cell, generating a number of zero padding bits for the DCI format 0_3 until a payload size of the DCI format 0_3 equals the payload size of the DCI format 1_3.

Example 67 includes the subject matter of Example 64, the operations further including, after performing size alignment, adjusting sizes of DCI format 0_3 or DCI format 1_3 for alignment in response to a determination that at least one of the number of DCI sizes for the DCI format for multi-cell scheduling exceeds the maximum number M or the number of DCI sizes with C-RNTI for the DCI format for multi-cell scheduling exceeds the maximum number N, adjusting including, in response to a further determination that a number of information bits in the DCI format 1_3 prior to padding is less than a payload size of the DCI format 0_3 for scheduling the serving cell, generating a number of zero padding bits for the DCI format 1_3 until a payload size of the DCI format 0_3 equals the payload size of the DCI format 0_3.

Example 68 includes the subject matter of any one of Examples 56-67, further including a Radio Frequency (RF) interface, and a front end module coupled to the RF interface.

Example 69 includes the subject matter of Example 68, further including one or more antennas coupled to the front end module to transmit the PDCCH.

Example 70 includes a machine-readable medium including code which, when executed, is to cause a machine to perform Example 71 includes the subject matter of any one of Examples 12-20 or 44-55.

Example 71 includes an apparatus including means to perform the method of any one of Examples 12-20 or 44-55.

Example X1 includes identifying a downlink control information (DCI) size budget and/or a maximum number of monitored PDCCH candidates and/or a maximum number of non-overlapped control channel elements (CCEs) related to one or more physical uplink shared channel (PUSCH) transmissions and/or one or more physical downlink shared channel (PDSCH) transmissions in more than one cell, generating a physical downlink control channel (PDCCH) transmission that includes an indication of the DCI size budget, and/or the maximum number of monitored PDCCH candidates and/or the maximum number of non-overlapped CCEs, and transmitting one or more PUSCH transmissions and/or processing one or more PDSCH transmissions based on the indication.

Example X2 includes identifying a received physical downlink control channel (PDCCH) transmission, identifying that the PDCCH transmission includes an indication of a downlink control information (DCI) size budget and/or a maximum number of monitored PDCCH candidates and/or a maximum number of non-overlapped control channel elements (CCEs) related to one or more physical uplink shared channel (PUSCH) transmissions and/or one or more physical downlink shared channel (PDSCH) transmissions in more than one cell, transmitting one or more PUSCH transmissions and/or processing one or more PDSCH transmissions based on the indication.

Example A1 may include the system and method of wireless communication to handle PDCCH monitoring capability for multi-cell scheduling: receiving, by UE, the configuration on the physical downlink control channel (PDCCH) monitoring, detecting, by UE, a PDCCH that is used schedule physical uplink shared channel (PUSCH) or physical downlink shared channel (PDSCH) in more than one cell.

Example A2 may include the method of Example A1, and/or some other example herein, wherein the DCI size budget is defined per cell or only for the scheduling cell.

Example A3 may include the method of Example A1, and/or some other example herein, wherein one from the following options is used to count a DCI format for multi-cell scheduling from the scheduling cell: as one DCI format of each cell that is scheduled by the DCI format:
as one DCI format of each cell that is scheduled by the DCI format and is not the scheduling cell. 1/Y DCI format of each cell that is scheduled by the DCI format, where Y is the maximum number of the cells that are scheduled by the DCI format.
as 1/Y DCI format of each cell that is scheduled by the DCI format and is not the scheduling cell, where Y is the maximum number of the cells that are scheduled by the DCI format and are not the scheduling cell.
as one DCI format of the scheduling cell only.
as one DCI format of a reference cell only.

Example A3.5 may include the method of Example A1, Example A3, and/or some other example herein, wherein a DCI used for the PUSCH and/or PDSCH is generated by the different configurations of a DCI format defined in the relevant 3GPP specifications for PDSCH or PUSCH scheduling.

Example A4 may include the method of Example A3 or some other example herein, wherein the reference cell is configured with the parameter nrofCandidates which configures the number of PDCCH candidates for the SS set with the DCI format.

Example A5 may include the method of Example A1, and/or some other example herein, wherein the DCI size budget of the scheduling cell is increased when multi-cell scheduling from the scheduling cell is configured.

Example A6 may include the method of Example A4, and/or some other example herein, wherein one from the following options is used to increase the DCI size budget of the scheduling cell: if a maximum of X cells are scheduled by the scheduling cell using multi-cell scheduling, the DCI size budget for the scheduling cell is scaled by X times:
if a maximum of X cells are scheduled by the scheduling cell using multi-cell scheduling, the DCI size budget for the scheduling cell is increased by X−1 or X
for each DCI format for multi-cell scheduling, if a maximum of Y cells is scheduled by a DCI format for multi-cell scheduling from the scheduling cell, the DCI size budget for the scheduling cell is increased by Y−1 or Y
for each cell that is schedulable by multiple DCI formats for multi-cell scheduling and is not the scheduling cell, the number of different DCI sizes of the multiple DCI formats are added to the DCI size budget of the scheduling cell.
for a DCI format for multi-cell scheduling on the scheduling cell, if the DCI format is counted toward the DCI size budget of the scheduling cell, the DCI size budget of the scheduling cell is increased by one.
for each DCI format for multi-cell scheduling that schedules the scheduling cell and other scheduled cell(s), the DCI size budget for the scheduling cell is increased by ½ or 1/Y, while for each DCI format for multi-cell scheduling that only schedules the scheduled cells other than the scheduling cell, the DCI size budget for the scheduling cell is increased by 1.

Example A7 may include the method of Example A1 or some other example herein, wherein for a DCI format for multi-cell scheduling, the DCI size budget of a reference cell that is scheduled by the DCI format is increased by ½ or (Y−1)/Y, while the DCI size budget of any other cells that can be scheduled by the DCI format is decreased by ½ or 1/Y.

Example A8 may include the method of Example A1 or some other example herein, wherein the DCI size budget of each serving cell is maintained, and for a cell that is scheduled by a DCI format for multi-cell scheduling, the DCI format is counted as ½ or 1/Y DCI size in the counting of DCI sizes of the cell.

Example A9 may include the method of Examples A2-8, and/or some other example herein, wherein if the number of sizes of DCI format for a cell exceeds the maximum numbers of the cell, DCI size alignment is performed until the resulting number of DCI sizes do not exceed the corresponding maximum numbers.

Example A10 may include the method of Example A1, and/or some other example herein, wherein the maximum number of monitored PDCCH candidates or non-overlapped CCEs for a cell is scaled by X times, if maximum of X cells are schedulable by the scheduling cell.

Example A11 may include the method of Example A1, and/or some other example herein, wherein to check the maximum number of monitored PDCCH candidates or non-overlapped CCEs, one from the following options is used to count the number of monitored PDCCH candidates or non-overlapped CCEs for a PDCCH candidate with AL L with a DCI format for multi-cell scheduling from the scheduling cell:
as one PDCCH candidate or L non-overlapped CCEs repeatedly toward each cell that is scheduled by the DCI format.
as one PDCCH candidate or L non-overlapped CCEs repeatedly toward each cell that is scheduled by the DCI format and is not the scheduling cell.
as Y PDCCH candidates or L·Y non-overlapped CCEs of the scheduling cell only. Y is the maximum number of the cells that are scheduled by the DCI format.
as Y PDCCH candidates or L·Y non-overlapped CCEs of a reference cell only.
as one PDCCH candidate or L non-overlapped CCEs of the scheduling cell only.
as one PDCCH candidate or L non-overlapped CCEs of a reference cell only.
as 1/Y PDCCH candidate or L/Y non-overlapped CCEs of each cell that is scheduled by the DCI format
as 1/Y PDCCH candidate or L/Y non-overlapped CCEs of each cell that is scheduled by the DCI format and is not the scheduling cell. Y is the maximum number of the cells that are scheduled by the DCI format and are not the scheduling cell

Example A12 may include the method of Example A11 or some other example herein, wherein the reference cell is configured with the parameter nrofCandidates which configures the number of PDCCH candidates for the SS set with the DCI format.

Example A13 may include the method of Example A1, and/or some other example herein, wherein to check the total number of monitored PDCCH candidates or non-overlapped CCEs, for a DCI format for multi-cell scheduling from the scheduling cell, a PDCCH candidate with AL L of the DCI format is counted as one PDCCH candidate or L non-overlapped CCEs

Example A14 may include the method of Example A1, and/or some other example herein, wherein to check the total number of monitored PDCCH candidates or non-overlapped CCEs, for a DCI format for multi-cell scheduling from the scheduling cell, a PDCCH candidate with ALL of the DCI format is counted as Y PDCCH candidates or L·Y non-overlapped CCEs, where Y is the maximum number of the cells that are scheduled by the DCI format.

Example A15 may include the method of Example A1 or some other example herein, wherein there is no limitation on the PDCCH candidates or non-overlapped CCEs caused by the monitoring of a DCI format for multi-cell scheduling

Example A16 may include the method of Example A1 or some other example herein, wherein the PDCCH candidates or non-overlapped CCEs caused by the monitoring of a DCI format for multi-cell scheduling is not considered in the checking of maximum numbers of PDCCH candidates or non-overlapped CCEs per cell

Example A17 may include the method of Example A1 or some other example herein, wherein for a DCI format for multi-cell scheduling, a subset of the cells that are schedulable by the DCI format are determined, which commonly applies in the counting of DCI sizes for the cells or counting the numbers of monitored PDCCH candidates or non-overlapped CCEs for the cells

Example A18 may include a method to be performed by a user equipment (UE), one or more elements of a UE, and/or an electronic device that includes a UE, wherein the method comprises: identifying a received physical downlink control channel (PDCCH) transmission; identifying that the PDCCH transmission includes an indication of a downlink control information (DCI) size budget and/or a maximum number of monitored PDCCH candidates and/or a maximum number of non-overlapped control channel elements (CCEs) related to one or more physical uplink shared channel (PUSCH) transmissions and/or one or more physical downlink shared channel (PDSCH) transmissions in more than one cell; and transmitting one or more PUSCH transmissions and/or processing one or more PDSCH transmissions based on the indication.

Example A19 may include a method to be performed by a base station, one or more elements of a base station, and/or an electronic device that includes a base station, wherein the method comprises: identifying a downlink control information (DCI) size budget and/or a maximum number of monitored PDCCH candidates and/or a maximum number of non-overlapped control channel elements (CCEs) related to one or more physical uplink shared channel (PUSCH) transmissions and/or one or more physical downlink shared channel (PDSCH) transmissions in more than one cell; generating a physical downlink control channel (PDCCH) transmission that includes an indication of the DCI size budget, and/or the maximum number of monitored PDCCH candidates and/or the maximum number of non-overlapped CCEs; and transmitting the PDCCH transmission to a user equipment (UE).

Example A20 includes the method of any of Examples A18-19, and/or some other example herein, wherein a DCI used for the PUSCH and/or PDSCH is generated by the different configurations of a DCI format defined in the relevant 3GPP specifications for PDSCH or PUSCH scheduling.

Example Z01 may include an apparatus comprising means to perform one or more elements of a method described in or related to any of Examples A1-A20, or any other method or process described herein.

Example Z02 may include one or more non-transitory computer-readable media comprising instructions to cause an electronic device, upon execution of the instructions by one or more processors of the electronic device, to perform one or more elements of a method described in or related to any of Examples A1-A20, or any other method or process described herein.

Example Z03 may include an apparatus comprising logic, modules, or circuitry to perform one or more elements of a method described in or related to any of Examples A1-A20, or any other method or process described herein.

Example Z04 may include a method, technique, or process as described in or related to any of Examples A1-A20, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of Examples A1-A20, or portions thereof.

Example Z06 may include a signal as described in or related to any of Examples A1-A20, or portions or parts thereof.

Example Z07 may include a datagram, packet, frame, segment, protocol data unit (PDU), or message as described in or related to any of Examples A1-A20, or portions or parts thereof, or otherwise described in the present disclosure.

Example Z08 may include a signal encoded with data as described in or related to any of Examples A1-A20, or portions or parts thereof, or otherwise described in the present disclosure.

Example Z09 may include a signal encoded with a datagram, packet, frame, segment, protocol data unit (PDU), or message as described in or related to any of Examples A1-A20, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of Examples A1-A20, or portions thereof.

Example Z11 may include a computer program comprising instructions, wherein execution of the program by a processing element is to cause the processing element to carry out the method, techniques, or process as described in or related to any of Examples A1-A20, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Example B1 may include an apparatus comprising means to perform one or more elements of a method described in or related to any of the method Examples above, or any other method or process described herein.

Example B2 may include one or more non-transitory computer-readable media comprising instructions to cause an electronic device, upon execution of the instructions by one or more processors of the electronic device, to perform one or more elements of a method described in or related to any of the method Examples above, or any other method or process described herein.

Example B3 may include an apparatus comprising logic, modules, or circuitry to perform one or more elements of a method described in or related to any of the method Examples above, or any other method or process described herein.

Example B4 may include a method, technique, or process as described in or related to any of the method Examples above, or portions or parts thereof.

Example B5 may include an apparatus comprising: one or more processors and one or more computer-readable media comprising instructions that, when executed by the one or more processors, cause the one or more processors to perform the method, techniques, or process as described in or related to any of the method Examples above, or portions thereof.

Example B6 may include a signal as described in or related to any of the method

Examples above, or portions or parts thereof.

Example B7 may include a datagram, packet, frame, segment, protocol data unit (PDU), or message as described in or related to any of the method Examples above, or portions or parts thereof, or otherwise described in the present disclosure.

Example B8 may include a signal encoded with data as described in or related to any of the method Examples above, or portions or parts thereof, or otherwise described in the present disclosure.

Example B9 may include a signal encoded with a datagram, packet, frame, segment, protocol data unit (PDU), or message as described in or related to any of the method Examples above, or portions or parts thereof, or otherwise described in the present disclosure.

Example B10 may include an electromagnetic signal carrying computer-readable instructions, wherein execution of the computer-readable instructions by one or more processors is to cause the one or more processors to perform the method, techniques, or process as described in or related to any of the method Examples above, or portions thereof.

Example B11 may include a computer program comprising instructions, wherein execution of the program by a processing element is to cause the processing element to carry out the method, techniques, or process as described in or related to any of the method Examples above, or portions thereof.

Example B12 may include a signal in a wireless network as shown and described herein.

Example B13 may include a method of communicating in a wireless network as shown and described herein.

Example B14 may include a system for providing wireless communication as shown and described herein.

Example B15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

1-25. (canceled)

26-45. (canceled)

46. An apparatus of a New Radio (NR) User Equipment (UE), the apparatus including one or more processors and a radio frequency (RF) circuitry interface to couple the one or more processors to an RF circuitry of the UE, the one or more processors to:
detect a received downlink control information (DCI) format for multi-cell scheduling; and
count the DCI format based on only a reference cell for counting the DCI format.

47. The apparatus of claim 46, wherein the reference cell for counting the DCI format is to correspond to a scheduling cell in response to a determination that the scheduling cell can be configured by the DCI format.

48. The apparatus of claim 46, wherein the reference cell for counting the DCI format is configured via higher layer signaling.

49. The apparatus of claim 48, wherein the higher layer signaling corresponds to a SearchSpace parameter.

50. The apparatus of claim 46, wherein the one or more processors are to monitor physical downlink control channel (PDCCH) candidates to detect a PDCCH candidate corresponding to the DCI format for multi-cell scheduling, monitoring including counting the PDCCH candidate or a number of corresponding non-overlapped control channel elements (CCEs) based on only a reference cell for counting the PDCCH candidate.

51. The apparatus of claim 50, wherein the reference cell for counting the PDCCH candidate corresponds to a scheduling cell.

52. The apparatus of claim 51, wherein the reference cell for counting the PDCCH candidate is to corresponds to the scheduling cell in response to a determination that the scheduling cell can be configured by the DCI format.

53. The apparatus of claim 50, wherein the reference cell for counting the PDCCH candidate is configured via higher layer signaling corresponding to a SearchSpace parameter.

54. The apparatus of claim 46, further including an RF front end coupled to the one or more processors.

55. The apparatus of claim 54, further including one or more antenna panels coupled to the RF front end.

56. One or more non-transitory computer-readable media comprising instructions to cause one or more processors of a New Radio (NR) User Equipment (UE), upon execution of the instructions, to perform operations including:
detecting a received downlink control information (DCI) format for multi-cell scheduling; and
counting the DCI format based on only a reference cell for counting the DCI format.

57. The one or more non-transitory computer-readable media of claim 56, wherein the reference cell for counting the DCI format corresponds to a scheduling cell.

58. The one or more non-transitory computer-readable media of claim 57, wherein the reference cell for counting the DCI format corresponds to the scheduling cell in response to a determination that the scheduling cell can be configured by the DCI format.

59. The one or more non-transitory computer-readable media of claim 56, wherein the reference cell for counting the DCI format is configured via higher layer signaling.

60. The one or more non-transitory computer-readable media of claim 59, wherein the higher layer signaling corresponds to a SearchSpace parameter.

61. The one or more non-transitory computer-readable media of claim 56, the operations further including monitoring physical downlink control channel (PDCCH) candidates to detect a PDCCH candidate corresponding to the DCI format for multi-cell scheduling, monitoring including counting the PDCCH candidate or a number of corresponding non-overlapped control channel elements (CCEs) based on only a reference cell for counting the PDCCH candidate.

62. The one or more non-transitory computer-readable media of claim 61, wherein the reference cell for counting the PDCCH candidate is to correspond to a scheduling cell in response to a determination that the scheduling cell can be configured by the DCI format.

63. The one or more non-transitory computer-readable media of claim 61, wherein the reference cell for counting the PDCCH candidate is configured via higher layer signaling, the higher layer signaling corresponding to a SearchSpace parameter.

64. A method to be performed at an apparatus of a New Radio (NR) User Equipment (UE), the method including:
detecting a received downlink control information (DCI) format for multi-cell scheduling; and
counting the DCI format based on only a reference cell for counting the DCI format.

65. The method of claim 64, wherein the reference cell for counting the DCI format is to correspond to a scheduling cell in response to a determination that the scheduling cell can be configured by the DCI format.
